(19) United States
(12) Patent Application Publication
(10) Pub. No.: US 2012/0026142 A1
(43) Pub. Date: Feb. 2, 2012

(54) PLASMA DISPLAY PANEL DRIVE METHOD AND PLASMA DISPLAY DEVICE

(75) Inventors: Yutaka Yoshihama, Osaka (JP); Kenji Ogawa, Osaka (JP)

(73) Assignee: Panasonic Corporation, Osaka (JP)

(21) Appl. No.: 13/255,112

(22) PCT Filed: Apr. 2, 2010
(86) PCT No.: PCT/JP2010/002437

§ 371 Date: Sep. 7, 2011

(30) Foreign Application Priority Data
Apr. 8, 2009 (JP) 2009-093812

(51) Int. Cl. G09G 3/28; G09G 5/00

(52) U.S. Cl. 345/208; 345/60

(57) ABSTRACT

The luminance of black level in an image displayed on a plasma display panel is reduced to enhance the contrast and image display quality. For this purpose, in an initializing period, one of a forced initializing waveform, a selective initializing waveform, and a non-initializing waveform is applied to scan electrodes. Further, one field is formed of a special initializing subfield where the forced initializing waveform and the non-initializing waveform are selectively generated, and a plurality of selective initializing subfields where only the selective initializing waveform is generated. The number of forced initializing waveforms applied to one scan electrode is one in one field group. The non-initializing waveform is applied to the scan electrodes on both sides of the scan electrode applied with the forced initializing waveform in a special initializing subfield, in at least two special initializing subfields, i.e. the special initializing subfield and a special initializing subfield immediately succeeding the special initializing subfield.

This application is a U.S. National Phase Application of PCT International Application PCT/JP2010/002437.

### TECHNICAL FIELD

The present invention relates to a driving method for a plasma display panel, and a plasma display device that are used in a wall-mounted television or a large monitor.

### BACKGROUND ART

A typical alternating-current surface discharge panel used as a plasma display panel (hereinafter, simply referred to as “panel”) has a large number of discharge cells that are formed between a front plate and a rear plate facing each other. The front plate has the following elements:
a plurality of display electrode pairs, each formed of a pair of scan electrode and sustain electrode, disposed on a front glass substrate parallel to each other; and
a dielectric layer and a protective layer formed so as to cover the display electrode pairs. The rear plate has the following elements:
a plurality of parallel data electrodes formed on a rear glass substrate;
a dielectric layer formed so as to cover the data electrodes;
a plurality of barrier ribs formed on the dielectric layer parallel to the data electrodes; and
phosphor layers formed on the surface of the dielectric layer and on the side faces of the barrier ribs.

The front plate and the rear plate face each other such that the display electrode pairs and the data electrodes three-dimensionally intersect, and are sealed together. A discharge gas containing xenon in a partial pressure ratio of 5%, for example, is sealed into the inside discharge space. Discharge cells are formed in portions where the display electrode pairs face the data electrodes. In a panel having such a structure, gas discharge generates ultraviolet light in each discharge cell. This ultraviolet light excites the red (R), green (G), and blue (B) phosphors so that the phosphors emit the respective colors for color display.

As a driving method for the panel, a subfield method is typically used. In the subfield method, one field is divided into a plurality of subfields, and light emission and no light emission in the respective discharge cells are controlled in the respective subfields. Then, the number of light emissions caused in one field is controlled for gradation display.

Each subfield has an initializing period, an address period, and a sustain period. In the initializing period, an initializing waveform is applied to the respective scan electrodes so as to cause an initializing discharge in the respective discharge cells. This initializing discharge forms wall charge necessary for the subsequent address operation in the respective discharge cells and generates priming particles (excitation particles for causing an address discharge) for causing the address discharge stably.

In the address period, a scan pulse is sequentially applied to the scan electrodes, and an address pulse corresponding to a signal of an image to be displayed is selectively applied to the data electrodes. Thereby, an address discharge is caused between the scan electrodes and the data electrodes so as to form wall charge in the discharge cells to be lit (hereinafter, this operation being also referred to as “addressing”).

In the sustain period, a sustain pulse is alternately applied to display electrode pairs, each formed of a scan electrode and a sustain electrode, at a number of times predetermined for each subfield. Thereby, a sustain discharge is caused in the discharge cells where the address discharge has formed wall charge, and thus causes the phosphor layers in the discharge cells to emit light. In this manner, an image is displayed in the image display area of the panel.

One of important factors in enhancing image display quality in a panel is to enhance contrast. As one of the subfield methods, a driving method for minimizing the light emission unrelated to gradation display so as to enhance the contrast ratio is disclosed.

In this driving method, the following operations are performed. In the initializing period of one subfield among a plurality of subfields forming one field, an initializing operation for causing an initializing discharge in all the discharge cells is performed. In the initializing periods of the other subfields, an initializing operation for causing an initializing discharge selectively in the discharge cells having undergone a sustain discharge in the immediately preceding sustain period is performed.

Luminance in an area displaying a black picture (hereinafter, simply referred to as “luminance of black level”) where no sustain discharge is caused is changed by the light emission unrelated to image display. Examples of such light emission include a light emission caused by the initializing discharge. In the above driving method, the light emission in the area displaying a black picture is only a weak light emission caused when an initializing operation is performed on all the discharge cells. This method can reduce the luminance of black level and thus allows the display of an image having a high contrast (see Patent Literature 1, for example).

Further, a technique for reducing luminance of black level so as to enhance visibility of black display is disclosed (see Patent Literature 2, for example). In this technique, an initializing period where an initializing waveform is applied to the discharge cells having undergone a discharge in the sustain period is set. This initializing waveform has a rising part including a gentle ramp portion where voltage gradually rises, and a falling part including a gentle ramp portion where the voltage gradually falls. Immediately before any one of the initializing periods in one field, a period where a weak discharge is caused between the sustain electrodes and the scan electrodes in all the discharge cells is set.

In the technique disclosed in Patent Literature 1, the initializing operation for causing an initializing discharge in all the discharge cells is performed once in a field. This operation can reduce the luminance of black level in the display image and thus enhance the contrast as compared with the case where an initializing discharge is caused in all the discharge cells in each subfield. However, with a recent increase in the screen size and definition of a panel, it is requested to further enhance the image display quality.

### CITATION LIST

[Patent Literature]

[PTL1]
Japanese Patent Unexamined Publication No. 2000-242224

[PTL2]
Japanese Patent Unexamined Publication No. 2004-37883

### SUMMARY OF THE INVENTION

In a driving method for a panel,
the panel having a plurality of discharge cells, the discharge cells having display electrode pairs, each of the display electrode pairs being formed of a scan electrode and a sustain electrode,
the panel displaying gradations such that a plurality of subfields is set in one field and each of the subfields has an initializing period, an address period, and a sustain period,
the driving method includes:
   applying any one of a forced initializing waveform, a selective initializing waveform and a non-initializing waveform to the scan electrodes, the forced initializing waveform causing an initializing discharge in the discharge cells irrespective of the operation in the immediately preceding subfield, the selective initializing waveform causing an initializing discharge only in the discharge cells having undergone a sustain discharge in the sustain period of the immediately preceding subfield, the non-initializing waveform for causing no initializing discharge in the discharge cells;
   forming one field from a special initializing subfield and a plurality of selective initializing subfields, the special initializing subfield being where the forced initializing waveform or the non-initializing waveform is selectively applied to the scan electrodes in the initializing period, and the plurality of selective initializing subfields being where the selective initializing waveform is applied to all the scan electrodes in the initializing period;
   forming one field group from the plurality of temporally consecutive fields, and setting the number of forced initializing waveforms to be applied to each scan electrode to one in one field group; and
   applying the non-initializing waveform to the scan electrodes on both sides of the scan electrode applied with the forced initializing waveform in the special initializing subfield, in at least two special initializing subfields including the special initializing subfield and a special initializing subfield immediately succeeding the special initializing subfield.

This operation can reduce the frequency of initializing discharges, which is one of major factors in increasing luminance of black level, and thus reduce the luminance of black level. Therefore, the contrast of the display image can be enhanced. When the frequency of initializing operations caused by the forced initializing waveform is reduced, flickering or linear noise is likely to occur on the image display surface. However, this operation can reduce such flickering or linear noise, and thus enhance the image display quality in the plasma display device.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel.

FIG. 3 is a waveform chart of driving voltages applied to the respective electrodes of the panel.

FIG. 4 is a circuit block diagram of a plasma display device in accordance with the first exemplary embodiment of the present invention.

FIG. 5 is a circuit diagram showing a configuration example of a scan electrode driving circuit of the plasma display device.

FIG. 6 is a timing chart for explaining an example of the operation of the scan electrode driving circuit in the initializing period of a specified-cell initializing subfield in accordance with the first exemplary embodiment of the present invention.

FIG. 7 is a schematic chart showing an example of the pattern of forced initializing waveforms and non-initializing waveforms generated in the initializing periods of specified-cell initializing subfields in accordance with the first exemplary embodiment.

FIG. 8 is a schematic chart showing an example of the structure for dividing respective fields into those where a forced initializing operation is performed on all the discharge cells of the panel at the same time and those where a non-initializing operation is performed on all the discharge cells at the same time.

FIG. 9 is a schematic chart showing an example of the structure where the continuity of temporal and positional changes of the discharge cells undergoing a forced initializing operation is high.

FIG. 10 is a schematic chart showing another example of the pattern of forced initializing waveforms and non-initializing waveforms generated in the initializing periods of specified-cell initializing subfields in accordance with the first exemplary embodiment of the present invention.

FIG. 11A is a schematic chart showing still another example of the pattern of forced initializing waveforms and non-initializing waveforms generated in the initializing periods of specified-cell initializing subfields in accordance with the first exemplary embodiment.

FIG. 11B is a schematic chart showing still another example of the pattern of forced initializing waveforms and non-initializing waveforms generated in the initializing periods of specified-cell initializing subfields in accordance with the first exemplary embodiment.

FIG. 12 is a schematic chart showing an example of the pattern of forced initializing waveforms and non-initializing waveforms generated in the initializing periods of special initializing subfields in accordance with a second exemplary embodiment of the present invention.

FIG. 13 is a schematic chart showing another example of the pattern of forced initializing waveforms and non-initializing waveforms generated in the initializing periods of special initializing subfields in accordance with the second exemplary embodiment.

FIG. 14 is a schematic chart showing still another example of the pattern of forced initializing waveforms and non-initializing waveforms generated in the initializing periods of special initializing subfields in accordance with the second exemplary embodiment.

FIG. 15 is a schematic chart showing yet another example of the pattern of forced initializing waveforms and non-initializing waveforms generated in the initializing periods of special initializing subfields in accordance with the second exemplary embodiment.

FIG. 16 is a schematic chart showing still another example of the pattern of forced initializing waveforms and non-initializing waveforms generated in the initializing periods of special initializing subfields in accordance with the second exemplary embodiment.

### DETAILED DESCRIPTION OF PREFERRED EMBODIMENTS

Hereinafter, a plasma display device in accordance with exemplary embodiments of the present invention will be described, with reference to the accompanying drawings.

### First Exemplary Embodiment

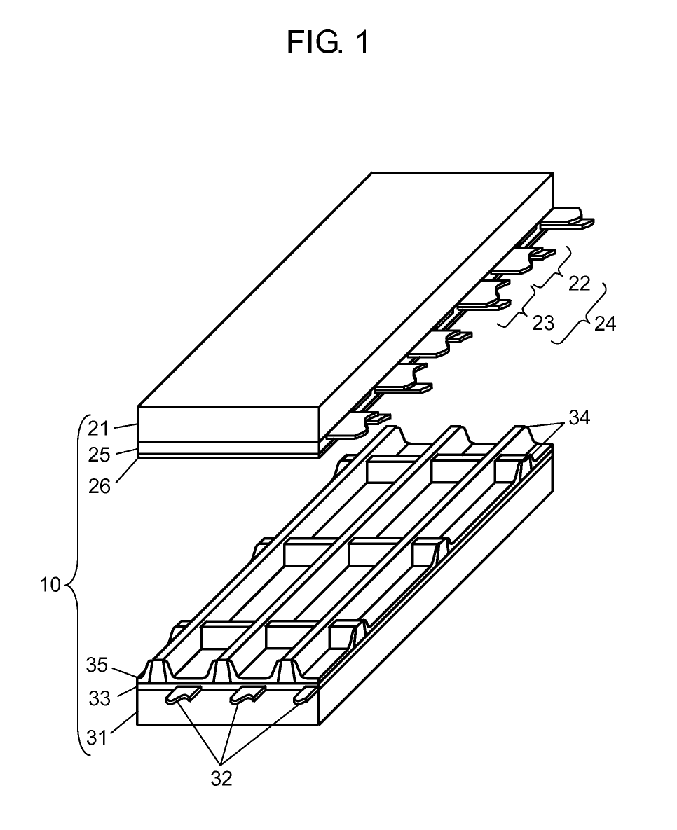

FIG. 1 is an exploded perspective view showing a structure of panel 10 in accordance with the first exemplary embodiment of the present invention. A plurality of display electrode pairs 24, each formed of scan electrode 22 and sustain electrode 23, is disposed on glass front plate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear plate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light in respective red (R), green (G), and blue (B) colors are formed.

Front plate 21 and rear plate 31 face each other such that display electrode pairs 24 intersect with data electrodes 32 with a small discharge space sandwiched between the electrodes. The outer peripheries of the plates are sealed with a sealing material, such as a glass frit. In the inside discharge space, a mixed gas of neon and xenon is sealed as a discharge gas. In this exemplary embodiment, a discharge gas having a xenon partial pressure of approximately 10% is used to improve the emission efficiency. The discharge space is partitioned into a plurality of compartments by barrier ribs 34. Discharge cells are formed in the intersecting parts of display electrode pairs 24 and data electrodes 32. The discharge cells discharge and emit light so as to display an image.

The structure of panel 10 is not limited to the above, and may include barrier ribs formed in a stripe pattern, for example. The mixing ratio of the discharge gas is not limited to the above numerical value, and other mixing ratios may be used.

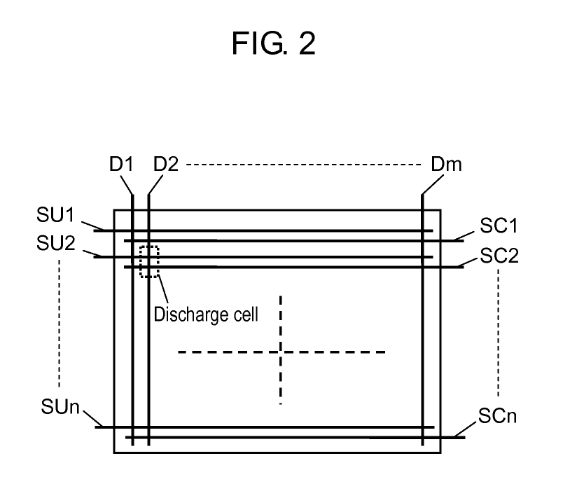

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both long in the row direction, and m data electrode D1 through data electrode Dm (data electrodes 32 in FIG. 1) long in the column direction. A discharge cell is formed in the part where a pair of scan electrode SCi (i being 1 through n) and sustain electrode SUi intersects with one data electrode Dk (k being 1 through m). Thus, m×n discharge cells are formed in the discharge space. The area where m×n discharge cells are formed is the display area of panel 10.

Next, driving voltage waveforms for driving panel 10 and the operation thereof are outlined. A plasma display device in this exemplary embodiment displays gradations by a subfield method. That is, one field is divided into a plurality of subfields along a temporal axis, a luminance weight is set for each subfield, and light emission or no light emission in each discharge cell is controlled in each subfield for gradation display on panel 10.

In this subfield (SF) method, one field is formed of eight subfields (the first SF, and the second SF through the eighth SF), and the respective subfields have luminance weights of 1, 2, 4, 8, 16, 32, 64, and 128, for example. In the sustain period of each subfield, sustain pulses equal in number to the luminance weight of the subfield multiplied by a predetermined luminance magnification are applied to respective display electrode pairs 24.

In the initializing period of one subfield among the plurality of subfields, a “special initializing operation” for selectively performing a “forced initializing operation” and a “non-initializing operation” is performed. In the initializing periods of the other subfields, a “selective initializing operation” is performed. These operations can minimize the light emission unrelated to gradation display and enhance the contrast ratio. The “forced initializing operation” is an initializing operation for causing an initializing discharge in the discharge cells irrespective of the operation in the immediately preceding subfield. The “non-initializing operation” is an operation for causing no initializing discharge by up-ramp voltage in the discharge cells in the initializing period. The up-ramp voltage will be described later. The “selective initializing operation” is an initializing operation for causing an initializing discharge only in the discharge cells having undergone a sustain discharge in the sustain period of the immediately preceding subfield. Hereinafter, a subfield where the special initializing operation is performed in the initializing period is referred to as “special initializing subfield”. A subfield where the selective initializing operation is performed in the initializing period is referred to as “selective initializing subfield”.

In this exemplary embodiment, one field is formed of eight subfields (the first SF, and the second SF through the eighth SF). In the initializing period of the first SF, a special initializing operation is performed. In the initializing periods of the second SF through the eight SF, a selective initializing operation is performed. With this structure, the light emission unrelated to image display is only the light emission caused by the discharge in the special initializing operation in the first SF. Therefore, luminance of black level, i.e. luminance in an area displaying a black picture where no sustain discharge is caused, is determined only by the weak light emission in the special initializing operation. This structure can reduce the luminance of black level in a display image and enhance the contrast.

However, in this exemplary embodiment, the number of subfields, or the luminance weight of each subfield is not limited to the above values. The subfield structure may be switched on the basis of image signals, for example.

This special initializing operation includes the following two operations: a specified-cell initializing operation for performing a forced initializing operation on specified discharge cells and a non-initializing operation on the other discharge cells; and an all-cell non-initializing operation for performing a non-initializing operation on all the discharge cells. However, in this exemplary embodiment, a description is provided for a structure where special initializing subfields are all specified-cell initializing subfields. Hereinafter, a subfield where a specified-cell initializing operation is performed in the initializing period is referred to as “specified-cell initializing subfield”, and a subfield where an all-cell non-initializing operation is performed in the initializing period is referred to as “all-cell non-initializing subfield”.

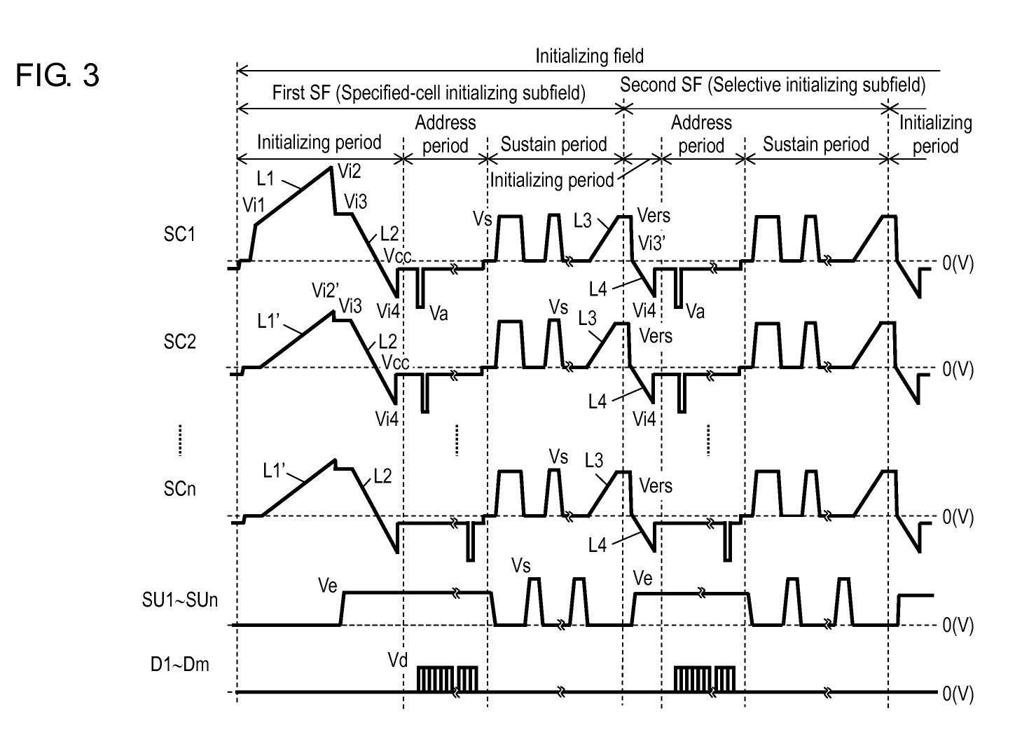

FIG. 3 is a waveform chart of driving voltages applied to the respective electrodes of panel 10 in accordance with the first exemplary embodiment of the present invention. FIG. 3 shows driving waveforms applied to the following electrodes: scan electrode SC1 for undergoing an address operation first in the address periods; scan electrode SC2 for undergoing an address operation second in the address periods; scan electrode SCn for undergoing an address operation last in the address periods (e.g. scan electrode SC1080); sustain electrode SU1 through sustain electrode SUn; and data electrode D1 through data electrode Dm.

FIG. 3 shows driving voltage waveforms in two subfields: the first subfield (first SF), i.e. a specified-cell initializing subfield; and the second subfield (second SF), i.e. a selective initializing subfield. Scan electrode SCi, sustain electrode SUi, and data electrode Dk in the following description show the electrodes selected among the respective electrodes based on subfield data. This subfield data is data showing light emission and no light emission in each subfield.

First, the first SF, i.e. a specified-cell initializing subfield, is described.

FIG. 3 shows a structure where a forced initializing waveform for causing an initializing discharge in the discharge cells irrespective of the operation in the immediately preceding subfield is applied to scan electrodes SC(1+6×N) in the (1+6×N)-th positions (N being integers) from the top, and a non-initializing waveform for causing no initializing discharge by up-ramp voltage in the discharge cells is applied to scan electrodes 22 other than electrodes SC(1+6×N).

In the first half of the initializing period of the first SF, 0 (V) is applied to each of data electrode D1 through data electrode Dm and sustain electrode SU1 through sustain electrode SUn. To scan electrodes SC(1+6×N), predetermined voltage Vi1, and ramp voltage (hereinafter, referred to as “up-ramp voltage”) L1, which rises from voltage Vi1 toward voltage Vi2 gently (with a gradient of approximately 0.5 V/μsec, for example), are applied. At this time, voltage Vi1 is a voltage lower than a breakdown voltage with respect to sustain electrodes SU(1+6×N), and voltage Vi2 is a voltage exceeding the breakdown voltage with respect to sustain electrodes SU(1+6×N).

While up-ramp voltage L1 is rising, a weak initializing discharge continuously occurs between scan electrodes SC(1+6×N) and sustain electrodes SU(1+6×N), and between scan electrodes SC(1+6×N) and data electrode D1 through data electrode Dm. Then, negative wall voltage accumulates on scan electrodes SC(1+6×N); positive wall voltage accumulates on data electrode D1 through data electrode Dm intersecting with scan electrodes SC(1+6×N), and sustain electrodes SU(1+6×N). Here, this wall voltage on the electrodes means the voltage generated by the wall charge that is accumulated on the dielectric layers covering the electrodes, the protective layer, the phosphor layers, or the like.

In the second half of the initializing period, the voltage applied to scan electrodes SC(1+6×N) is lowered from voltage Vi2 to voltage Vi3, which is lower than voltage Vi2. Positive voltage Ve is applied to sustain electrode SU1 through sustain electrode SUn and 0 (V) is applied to data electrode D1 through data electrode Dm. To scan electrodes SC(1+6×N), ramp voltage (hereinafter, referred to as “down-ramp voltage”) L2, which falls from voltage Vi3 toward negative voltage Vi4 gently (with a gradient of approximately −0.5 V/μsec, for example), is applied. At this time, voltage Vi3 is a voltage lower than the breakdown voltage with respect to sustain electrodes SU(1+6×N), and voltage Vi4 is a voltage exceeding the breakdown voltage with respect to sustain electrodes SU(1+6×N).

During this application, a weak initializing discharge occurs between scan electrodes SC(1+6×N) and sustain electrodes SU(1+6×N), and between scan electrodes SC(1+6×N) and data electrode D1 through data electrode Dm. This weak discharge reduces the negative wall voltage on scan electrodes SC(1+6×N), and the positive wall voltage on sustain electrodes SU(1+6×N), and adjusts the positive wall voltage on data electrode D1 through data electrode Dm intersecting with scan electrodes SC(1+6×N) to a value appropriate for the address operation.

The above waveform is the forced initializing waveform for causing an initializing discharge in the discharge cells irrespective of the operation in the immediately preceding subfield. The above operation of applying the forced initializing waveform to scan electrodes 22 is the forced initializing operation. On the other hand, the following operations are performed on scan electrodes 22 other than scan electrodes SC(1+6×N). That is, in the first half of the initializing period of the first SF, instead of application of predetermined voltage Vi1, 0 (V) is kept, and up-ramp voltage L1′, which gently rises from 0 (V) toward voltage Vi2′, is applied to the above electrodes. Here, this up-ramp voltage L1′ continues to rise for a period equal to that of up-ramp voltage L1 with a gradient equal to that of up-ramp voltage L1. Therefore, voltage Vi2′ is equal to a voltage obtained by subtracting voltage Vi1 from voltage Vi2. At this time, each voltage and up-ramp voltage L1′ are set such that voltage Vi2′ is lower than the breakdown voltage with respect to sustain electrodes 23. With this setting, substantially no discharge occurs in the discharge cells applied with up-ramp voltage L1′.

In the second half of the initializing period, down-ramp voltage L2 is applied also to electrodes 22 other than scan electrodes SC(1+6×N), in a manner similar to that of scan electrodes SC(1+6×N).

The above waveform is the non-initializing waveform for causing no initializing discharge by up-ramp voltage in the discharge cells. The above operation of applying the non-initializing waveform to scan electrodes 22 is the non-initializing operation.

The forced initializing waveform in the present invention is not limited to the above waveform. Any waveform may be used as long as the waveform causes an initializing discharge in the discharge cells irrespective of the operation in the immediately preceding subfield. The non-initializing waveform in the present invention is not limited to the above waveform. The non-initializing waveform in this exemplary embodiment only shows an example of the waveform for causing no initializing discharge in the discharge cells. Any waveform, e.g. a waveform for clamping the voltage to 0 (V), may be used as long as the waveform causes no initializing discharge.

In this manner, the specified-cell initializing operation is completed. That is, the forced initializing waveform is applied to predetermined ones (e.g. scan electrodes SC(1+6×N)) of scan electrodes 22 and the non-initializing waveform is applied to the other ones of scan electrodes 22, for the forced initializing operation in the specified discharge cells and the non-initializing operation in the other discharge cells.

In the subsequent address period, scan pulse voltage Va is sequentially applied to scan electrode SC1 through scan electrode SCn. Positive address pulse voltage Vd is applied to data electrode Dk (k being 1 through m) corresponding to a discharge cell to be lit among data electrode D1 through data electrode Dm. Thus, an address discharge is caused selectively in the respective discharge cells.

Specifically, first, voltage Ve is applied to sustain electrode SU1 through sustain electrode SUn, and voltage Vcc is applied to scan electrode SC1 through scan electrode SCn.

Next, negative scan pulse voltage Va is applied to scan electrode SC1 in the first position (the first row) from the top, and positive address pulse voltage Vd is applied to data electrode Dk (k being 1 through m) of the discharge cell to be lit in the first row among data electrode D1 through data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd−voltage Va), and thus exceeds the breakdown voltage. Then, a discharge occurs between data electrodes Dk and scan electrode SC1. Since voltage Ve is applied to sustain electrode SU1 through sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve−voltage Va). At this time, setting voltage Ve to a value slightly lower than the breakdown voltage can make a state where a discharge is likely to occur but not actually occurs between sustain electrode SU1 and scan electrode SC1. With this setting, the discharge caused between data electrode Dk and scan electrode SC1 can trigger a discharge between the areas of sustain electrode SU1 and scan electrode SC1 intersecting with data electrode Dk. Thus, an address discharge occurs in the discharge cells to be lit. Positive wall voltage accumulates on scan electrode SC1 and negative wall voltage accumulates on sustain electrode SU1. Negative wall voltage also accumulates on data electrode Dk.

In this manner, the address discharge is caused in the discharge cells to be lit in the first row so as to accumulate wall voltages on the respective electrodes. On the other hand, the voltage in the intersecting parts of scan electrode SC1 and data electrode D1 through data electrode Dm applied with no address pulse voltage Vd does not exceed the breakdown voltage, and thus no address discharge occurs. The above address operation is sequentially performed until the operation reaches the discharge cells in the n-th row, and the address period is completed.

In the subsequent sustain period, sustain pulses equal in number to the luminance weight multiplied by a predetermined luminance magnification are alternately applied to display electrode pairs 24. Thereby, a sustain discharge is caused in the discharge cells having undergone an address discharge. In this manner, the discharge cells having undergone an address discharge are caused to emit light.

Specifically, first, positive sustain pulse voltage Vs is applied to scan electrode SC1 through scan electrode SCn, and a ground potential as a base potential, i.e. 0 (V), is applied to sustain electrode SU1 through sustain electrode SUn. Then, in the discharge cells having undergone an address discharge, the voltage difference between scan electrode SCi and sustain electrode SUi is obtained by adding the difference between the wall voltage on scan electrode SCi and the wall voltage on sustain electrode SUi to sustain pulse voltage Vs, and thus exceeds the breakdown voltage.

Then, a sustain discharge occurs between scan electrode SCi and sustain electrode SUi, and ultraviolet light generated at this time causes phosphor layers 35 to emit light. Thus, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs.

Subsequently, 0 (V) as the base potential is applied to scan electrode SC1 through scan electrode SCn, and sustain pulse voltage Vs is applied to sustain electrode SU1 through sustain electrode SUn. In the discharge cell having undergone a sustain discharge, the voltage difference between sustain electrode SUi and scan electrode SCi exceeds the breakdown voltage. Thereby, a sustain discharge occurs between sustain electrode SUi and scan electrode SCi again. Thus, negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn so as to cause a potential difference between the electrodes of display electrode pairs 24. Thereby, the sustain discharge is continued in the discharge cells having undergone an address discharge in the address period.

After the sustain pulses have been generated in the sustain period, ramp voltage (hereinafter, referred to as “erasing ramp voltage”) L3 is applied to scan electrode SC1 through scan electrode SCn while 0 (V) is applied to sustain electrode SU1 through sustain electrode SUn and data electrode D1 through data electrode Dm. Here, this erasing ramp voltage rises gently (with a gradient of approximately 10 V/μsec, for example) from 0 (V) toward voltage Vers, which exceeds the breakdown voltage. Thereby, between sustain electrode SUi and scan electrode SCi in the discharge cell having undergone a sustain discharge, a weak discharge continuously occurs. The charged particles generated by this weak discharge accumulate on sustain electrode SUi and scan electrode SCi, as wall charge, so as to reduce the voltage difference between sustain electrode SUi and scan electrode SCi. With this operation, the wall voltage on scan electrode SCi and the wall voltage on sustain electrode SUi are reduced to the difference between the voltage applied to scan electrode SCi and the breakdown voltage, e.g. a level of (voltage Vers−breakdown voltage), while the positive wall voltage is left on data electrode Dk.

Thereafter, the voltage applied to scan electrode SC1 through scan electrode SCn is returned to 0 (V), and the sustain operation in the sustain period is completed.

Next, the second SF, a selective initializing subfield, is described. In the initializing period of the second SF, a selective initializing waveform is applied to all scan electrodes 22. The selective initializing waveform in this exemplary embodiment is a driving voltage waveform where the first half of the forced initializing waveform is omitted. Specifically, voltage Ve is applied to sustain electrode SU1 through sustain electrode SUn, 0 (V) is applied to data electrode D1 through data electrode Dm, and down-ramp voltage L4 is applied to scan electrode SC1 through scan electrode SCn. Here, down-ramp voltage L4 falls from a voltage lower than the breakdown voltage (e.g. 0 (V)) toward negative voltage Vi4 with a gradient equal to that of down-ramp voltage L2.

This application causes a weak initializing discharge in the discharge cells having undergone a sustain discharge in the sustain period of the immediately preceding subfield (the first SF in FIG. 3). Thus, the wall voltages on scan electrode SCi and sustain electrode SUi are reduced, and the wall voltage on data electrode Dk (k being 1 through m) is adjusted to a value appropriate for the address operation.

The above waveform is the selective initializing waveform for causing an initializing discharge only in the discharge cells having undergone a sustain discharge in the sustain period of the immediately preceding subfield. The above operation of applying the selective initializing waveform to all scan electrodes 22 is the selective initializing operation. In this manner, the selective initializing operation in the initializing period of the selective initializing subfield is completed.

The selective initializing waveform of the present invention is not limited to the above waveform. Any waveform may be used as long as the waveform causes an initializing discharge only in the discharge cells having undergone a sustain discharge in the sustain period of the immediately preceding subfield. For example, in this exemplary embodiment, a description is provided for a structure where down ramp voltage L4 is generated with one gradient. However, down-ramp voltage L4 may be divided for a plurality of sub-periods and generated with gradients different in the respective sub-periods. In the address period of the second SF, the driving waveforms identical with those in the address period of the first SF are applied to the respective electrodes. In the sustain period of the second SF, the driving waveforms identical with those in the sustain period of the first SF except for the number of sustain pulses are applied to the respective electrodes.

In the third SF and the subfields thereafter, the driving waveforms identical with those in the second SF except for the number of sustain pulses in the sustain periods are applied to the respective electrodes.

The above description has outlined the driving voltage waveforms applied to the respective electrodes of panel 10 in this exemplary embodiment.

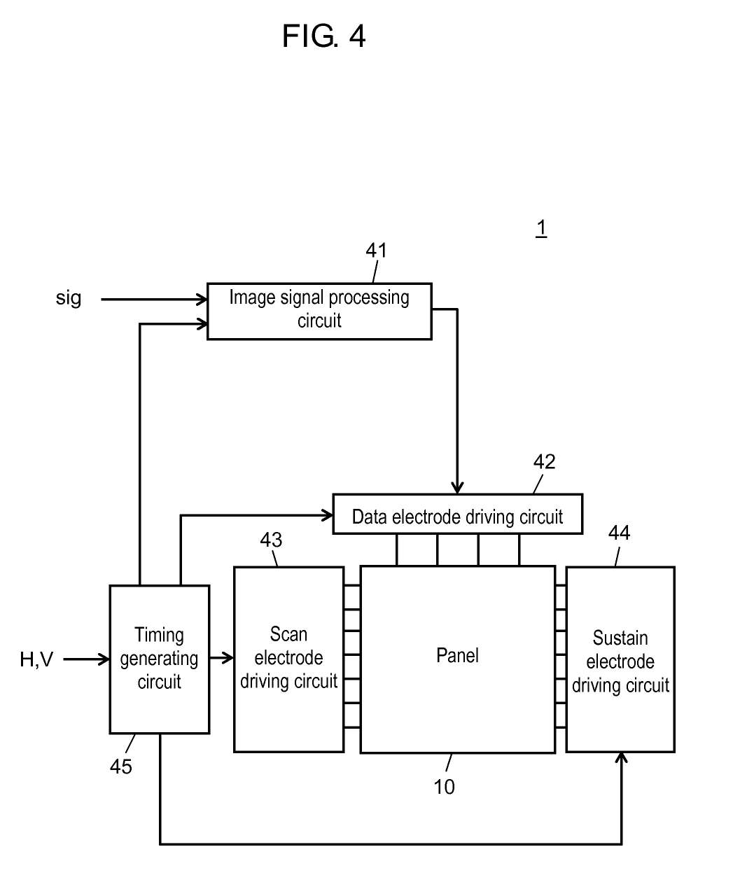

Next, the structure of a plasma display device in this exemplary embodiment is described. FIG. 4 is a circuit block diagram of plasma display device 1 in accordance with the first exemplary embodiment of the present invention. Plasma display device 1 has the following elements:
panel 10;
image signal processing circuit 41;
data electrode driving circuit 42;
scan electrode driving circuit 43;
sustain electrode driving circuit 44;
timing generating circuit 45; and
power supply circuits (not shown) for supplying power necessary for each circuit block.

Image signal processing circuit 41 converts input image signal sig into subfield data showing light emission and no light emission in each subfield, based on the number of pixels in panel 10.

Timing generating circuit 45 generates various timing signals for controlling the operation of each circuit block based on horizontal synchronizing signal H and vertical synchronizing signal V, and supplies the timing signals to the respective circuit blocks (image signal processing circuit 41, data electrode driving circuit 42, scan electrode driving circuit 43, and sustain electrode driving circuit 44).

Data electrode driving circuit 42 converts subfield data in each subfield into signals corresponding to each of data electrode D1 through data electrode Dm, and drives each of data electrode D1 through data electrode Dm, in response to the timing signals supplied from timing generating circuit 45. Scan electrode driving circuit 43 has the following elements:
an initializing waveform generating circuit for generating initializing waveforms to be applied to scan electrode SC1 through scan electrode SCn in the initializing periods;
a sustain pulse generating circuit for generating sustain pulses to be applied to scan electrode SC1 through scan electrode SCn in the sustain periods; and
a scan pulse generating circuit having a plurality of scan electrode driving integrated circuits (hereinafter, simply referred to as “scan ICs”), for generating a scan pulse to be applied to scan electrode SC1 through scan electrode SCn in the address periods. The scan electrode driving circuit drives each of scan electrode SC1 through scan electrode SCn, in response to the timing signals supplied from timing generating circuit 45.

Sustain electrode driving circuit 44 has a sustain pulse generating circuit and a circuit for generating voltage Ve, and drives sustain electrode SU1 through sustain electrode SUn, in response to the timing signals supplied from timing generating circuit 45.

Next, the details and operation of scan electrode driving circuit 43 are described.

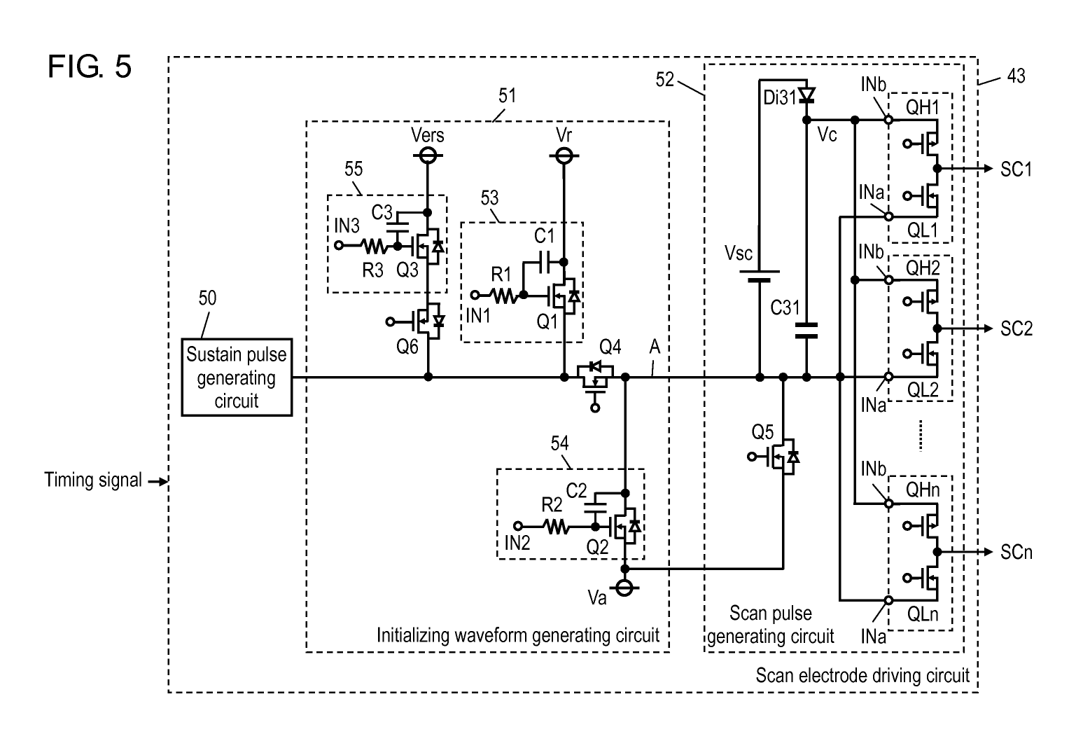

FIG. 5 is a circuit diagram showing a configuration example of scan electrode driving circuit 43 of plasma display device 1 in accordance with the first exemplary embodiment of the present invention. Scan electrode driving circuit 43 has the following elements:
sustain pulse generating circuit 50 for generating sustain pulses;
initializing waveform generating circuit 51 for generating initializing waveforms; and
scan pulse generating circuit 52 for generating scan pulses. The respective output terminals of scan pulse generating circuit 52 are connected to scan electrode SC1 through scan electrode SCn of panel 10. In this exemplary embodiment, the voltage input to scan pulse generating circuit 52 is denoted as “reference potential A”. In the following description, the operation of bringing a switching element into conduction is denoted as “ON”, and the operation of bringing a switching element out of conduction is denoted as “OFF”. A signal for setting a switching element to ON is denoted as “Hi”, and a signal for setting a switching element to OFF is denoted as “Lo”.

FIG. 5 shows a separating circuit using switching element Q4, for electrically separating sustain pulse generating circuit 50, a circuit based on voltage Vr (e.g. Miller integrating circuit 53), and a circuit based on voltage Vers (e.g. Miller integrating circuit 55) from a circuit based on negative voltage Va (e.g. Miller integrating circuit 54) while the latter circuit is operated. The diagram also shows a separating circuit using switching element Q6, for electrically separating a circuit based on voltage Vers (e.g. Miller integrating circuit 55), which is lower than voltage Vr, from a circuit based on voltage Vr (e.g. Miller integrating circuit 53) while the latter circuit is operated.

Sustain pulse generating circuit 50 has a generally-used power recovery circuit and clamp circuit, and generates sustain pulses by switching the respective switching elements included therein, in response to the timing signals output from timing generating circuit 45. In FIG. 5, the details of the paths of the timing signals are omitted.

Scan pulse generating circuit 52 has switching element QH1 through switching element QHn and switching element QL1 through switching element QLn for applying a scan pulse to n scan electrode SC1 through scan electrode SCn, respectively. One terminal of switching element QHj (j being 1 through n) is interconnected to one terminal of switching element QLj. The interconnected part forms an output terminal of scan pulse generating circuit 52 and is connected to scan electrode SCj. The other terminal of switching element QHj is input terminal INb; the other terminal of switching element QLj is input terminal INa. Switching element QH1 through switching element QHn and switching element QL1 through switching element QLn are grouped in a plurality of outputs and formed into ICs. These ICs are scan ICs.

Scan pulse generating circuit 52 has the following elements:
switching element Q5 for connecting reference potential A to negative voltage Va in the address periods; and
power supply VSC, diode D131, and capacitor C31 for generating voltage Vc, where voltage Vsc is superimposed on reference potential A. Voltage Vc is connected to input terminal INb of each of switching element QH1 through switching element QHn; reference potential A is connected to input terminal INa of each of switching element QL1 through switching element QLn.

In scan pulse generating circuit 52 thus configured, switching element Q5 is set to ON so as to make reference potential A equal to negative voltage Va, and negative voltage Va is applied to input terminal INa in the address periods. Voltage Vc (voltage Vcc in FIG. 3), i.e. voltage Va+voltage Vsc, is applied to input terminal INb. Then, based on subfield data, the following operations are performed. To scan electrode SCi to be applied with a scan pulse, negative scan pulse voltage Va is applied via switching element QLi, by setting switching element QHi to OFF and switching element QLi to ON. To scan electrode SCh to be applied with no scan pulse (h being 1 through n except i), voltage Va+voltage Vsc is applied via switching element QHh, by setting switching element QLh to OFF and switching element QHh to ON.

Scan pulse generating circuit 52 is controlled by timing generating circuit 45 so as to output the voltage waveforms in sustain pulse generating circuit 50, in the sustain periods.

The details of the operation of scan pulse generating circuit 52 in the initializing periods will be described later.

Initializing waveform generating circuit 51 has Miller integrating circuit 53, Miller integrating circuit 54, and Miller integrating circuit 55. FIG. 5 shows the input terminal of Miller integrating circuit 53 as input terminal IN1, the input terminal of Miller integrating circuit 54 as input terminal IN2, and the input terminal of Miller integrating circuit 55 as input terminal IN3. Each of Miller integrating circuit 53 and Miller integrating circuit 55 is a ramp voltage generating circuit for generating a rising ramp voltage. Miller integrating circuit 54 is a ramp voltage generating circuit for generating a falling ramp voltage.

Miller integrating circuit 53 has switching element Q1, capacitor C1, and resistor R1. In the initializing operation, this Miller integrating circuit generates up-ramp voltage L1′, by causing reference potential A of scan electrode driving circuit 43 to rise to voltage Vi2′ gently (with a gradient of 0.5 V/μsec, for example) in a ramp form.

Miller integrating circuit 55 has switching element Q3, capacitor C3, and resistor R3. At the end of each sustain period, this Miller integrating circuit generates erasing ramp voltage L3, by causing reference potential A to rise to voltage Vers with a gradient (e.g. 10 V/μsec) steeper than that of up-ramp voltage L1.

Miller integrating circuit 54 has switching element Q2, capacitor C2, and resistor R2. In the initializing operation, this Miller integrating circuit generates down-ramp voltage L2, by causing reference potential A to fall to voltage Vi4 gently (with a gradient of −0.5 V/μsec, for example) in a ramp form.

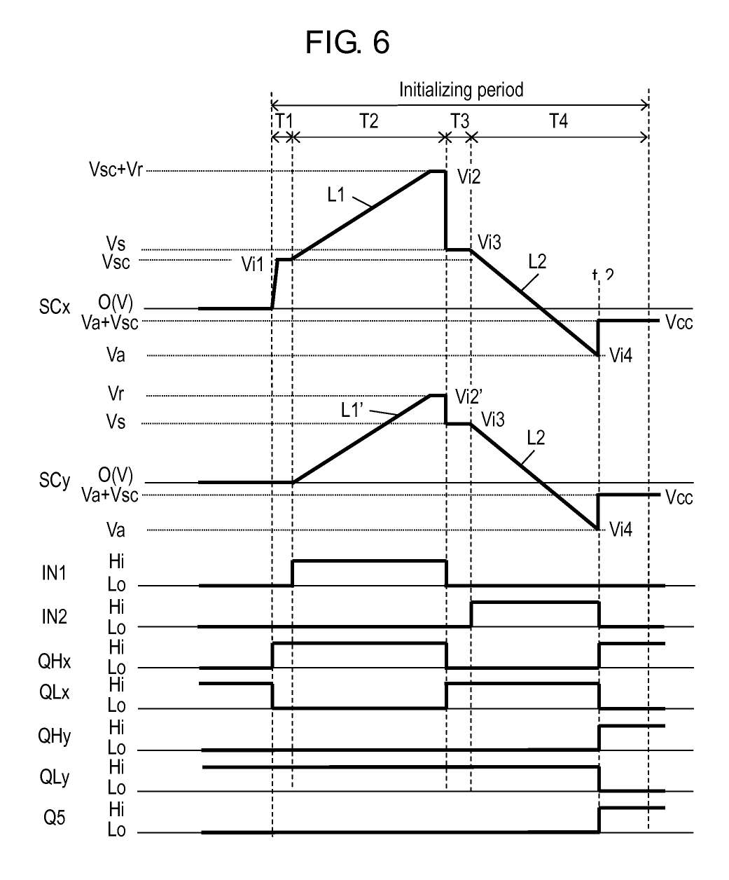

Next, with reference to FIG. 6, a description is provided for the operation of generating a forced initializing waveform and a non-initializing waveform in the initializing period of a specified-cell initializing subfield.

FIG. 6 is a timing chart for explaining an example of the operation of scan electrode driving circuit 43 in the initializing period of a specified-cell initializing subfield in accordance with the first exemplary embodiment of the present invention. In this chart, scan electrode 22 to be applied with a forced initializing waveform is denoted as “scan electrode SCx”, and scan electrode 22 to be applied with a non-initializing waveform as “scan electrode SCy”. The description of the operation of scan electrode driving circuit 43 when a selective initializing waveform is generated in a selective initializing subfield is omitted. However, the operation of generating down-ramp voltage L4, i.e. a selective initializing waveform, is the same as the operation of generating down-ramp voltage L2 of FIG. 6.

In FIG. 6, the initializing period is divided into four sub-periods shown by sub-period T1 through sub-period T4, and each sub-period is described. In the following description, voltage Vi1 is equal to voltage Vsc, voltage Vi2 is equal to voltage Vsc+voltage Vr, voltage Vi2′ is equal to voltage Vr, voltage Vi3 is equal to voltage Vs used to generate sustain pulses, and voltage Vi4 is equal to negative voltage Va. In the chart, a signal for setting a switching element to ON is denoted as “Hi”, and a signal for setting a switching element to OFF as “Lo”.

FIG. 6 shows an example where voltage Vs is set to a value higher than voltage Vsc. However, voltage Vs and voltage Vsc may be at an equal value, or voltage Vs may be lower than voltage Vsc.

First, before sub-period T1, the clamp circuit of sustain pulse generating circuit 50 is operated so as to set reference potential A to 0 (V). Next, switching element QH1 through switching element QHn are set to OFF and switching element QL1 through switching element QLn are set to ON, so that reference potential A, i.e. 0 (V), is applied to scan electrode SC1 through scan electrode SCn.

### (Sub-Period T1)

In sub-period T1, switching element QHx connected to scan electrode SCx is set to ON, and switching element QLx connected thereto is set to OFF. Thereby, voltage Vc where voltage Vsc is superimposed on reference potential A (0 (V) at this time), i.e. voltage Vc=voltage Vsc, is applied to scan electrode SCx to be applied with a forced initializing waveform.

On the other hand, switching element QHy connected to scan electrode SCy is kept at OFF, and switching element QLy connected thereto is kept at ON. Thereby, reference potential A, i.e. 0 (V), is applied to scan electrode SCy to be applied with a non-initializing waveform.

### (Sub-Period T2)

In sub-period T2, switching element QH1 through switching element QHn, and switching element QL1 through switching element QLn are kept in a state equal to that in sub-period T1. That is, switching element QHx connected to scan electrode SCx is kept at ON, and switching element QLx connected thereto is kept at OFF. Switching element QHy connected to scan electrode SCy is kept at OFF, and switching element QLy connected thereto is kept at ON. Next, input terminal IN1 of Miller integrating circuit 53 for generating up-ramp voltage L1′ is set to “Hi”. Specifically, a predetermined constant current is input to input terminal IN1. Then, the constant current flows toward capacitor C1, the source voltage of switching element Q1 rises in a ramp form, and reference potential A starts to rise from 0 (V) in a ramp form. This voltage rise can be continued in the period during which input terminal IN1 is set to “Hi” or until reference potential A reaches voltage Vr.

At this time, the constant current input to input terminal IN1 is generated such that the gradient of the ramp voltage is at a desired value (e.g. 0.5 V/μsec). In this manner, up-ramp voltage L1′, which rises from 0 (V) toward voltage Vi2′ (equal to voltage Vr in this exemplary embodiment), is generated. Since switching element QHy is set to OFF and switching element QLy is set to ON, this up-ramp voltage L1′ is applied to scan electrode SCy without any change.

On the other hand, since switching element QHx is set to ON and switching element QLx is set to OFF, a voltage where voltage Vsc is superimposed on this up-ramp voltage L1′ is applied to scan electrode SCx. That is, the application voltage is up-ramp voltage L1, which rises from voltage Vi1 (equal to voltage Vsc in this exemplary embodiment) toward voltage Vi2 (equal to voltage Vsc+voltage Vr in this exemplary embodiment).

### (Sub-Period T3)

In sub-period T3, input terminal IN1 is set to “Lo”. Specifically, the input of the constant current to input terminal IN1 is stopped. Thus, the operation of Miller integrating circuit 53 is stopped. Switching element QH1 through switching element QHn are set to OFF and switching element QL1 through switching element QLn are set to ON, so that reference potential A is applied to scan electrode SC1 through scan electrode SCn. Further, the clamp circuit of sustain pulse generating circuit 50 is operated so as to set reference potential A to voltage Vs. Thereby, the voltage of scan electrode SC1 through scan electrode SCn falls to voltage Vi3 (equal to voltage Vs in this exemplary embodiment).

### (Sub-Period T4)

In sub-period T4, switching element QH1 through switching element QHn, and switching element QL1 through switching element QLn are kept in a state equal to that in sub-period T3.

Next, input terminal IN2 of Miller integrating circuit 54 for generating down-ramp voltage L2 is set to “Hi”. Specifically, a predetermined constant current is input to input terminal IN2. Thereby, the constant current flows toward capacitor C2, and the drain voltage of switching element Q2 starts to fall in a ramp form. The output voltage of scan electrode driving circuit 43 starts to fall toward negative voltage Vi4 in a ramp form. This voltage drop can be continued in the period during which input terminal IN2 is set to “Hi” or until reference potential A reaches voltage Va.

At this time, the constant current input to input terminal IN2 is generated such that the gradient of the ramp voltage is at a desired value (e.g. −0.5 V/μsec).

When the output voltage of scan electrode driving circuit 43 reaches negative voltage Vi4 (equal to voltage Va in this exemplary embodiment), input terminal IN2 is set to “Lo”. Specifically, the constant current input to input terminal IN2 is stopped. Thus, the operation of Miller integrating circuit 54 is stopped.

In this manner, down-ramp voltage L2, which falls from voltage Vi3 (equal to voltage Vs in this exemplary embodiment) toward negative voltage Vi4, is generated and applied to scan electrode SC1 through scan electrode SCn.

After the operation of Miller integrating circuit 54 is stopped by setting input terminal IN2 to “Lo”, switching element Q5 is set to ON so that reference potential A is set to voltage Va. Further, switching element QH1 through switching element QHn are set to ON, and switching element QL1 through switching element QLn are set to OFF. Thereby, voltage Vc where voltage Vsc is superimposed on reference potential A, i.e. voltage Vcc (equal to voltage Va+voltage Vsc in this exemplary embodiment), is applied to scan electrode SC1 through scan electrode SCn, as preparation for the subsequent address period.

In this exemplary embodiment, a forced initializing waveform and a non-initializing waveform are generated in the initializing period of a specified-cell initializing subfield in this manner. By controlling switching element QH1 through switching element QHn and switching element QL1 through switching element QLn, the forced initializing waveform and the non-initializing waveform can be applied to scan electrodes 22 selectively. For example, the forced initializing waveform is applied to scan electrode SCx and the non-initializing waveform is applied to scan electrode SCy.

Each of down-ramp voltage L2 and down-ramp voltage L4 may be dropped to voltage Va as shown in FIG. 6. However, for example, the voltage drop may be stopped when the falling voltage reaches the voltage where predetermined positive voltage Vset2 is superimposed on voltage Va. Further, each of down-ramp voltage L2 and down-ramp voltage L4 may be raised immediately after having reached a preset voltage. However, for example, after the falling voltage has reached a preset voltage, the preset voltage may be maintained for a fixed period.

Next, a description is provided for rules applied when forced initializing waveforms and non-initializing waveforms are generated in the initializing periods of specified-cell initializing subfields in this exemplary embodiment. One of important factors in enhancing image display quality in plasma display device 1 is to enhance the contrast of the image displayed on panel 10. In order to enhance the contrast in panel 10, at least either of the following operations is performed. The maximum value of the luminance of the display image is increased, or the minimum value of the luminance of the display image, i.e. luminance of black level, is decreased. At this time, in consideration of the general environment for viewing a television at home, enhancing the contrast by decreasing luminance of black level is considered more important in enhancing the image display quality.

Luminance of black level is changed by light emission unrelated to image display. Thus, the luminance of black level can be decreased by reducing the light emission unrelated to image display. Major examples of the light emission unrelated to image display include the light emission caused by initializing discharge. However, the above selective initializing operation causes no discharge in the discharge cells having undergone no sustain discharge in the immediately preceding subfield, and thus exerts substantially no influence on the brightness of luminance of black level. In contrast, the above forced initializing operation causes an initializing discharge in the discharge cells irrespective of the operation in the immediately preceding subfield, and thus exerts influence on the brightness of luminance of black level.

In this exemplary embodiment, the luminance of black level in the display image is decreased by reducing the frequency of the forced initializing operations.

That is, in this exemplary embodiment, a plurality of temporally consecutive fields forms a field group, and a plurality of positionally consecutive scan electrodes 22 forms a scan electrode group. Further, forced initializing operations and non-initializing operations are performed in accordance with the following rules.

*The number of forced initializing waveforms applied to one scan electrode 22 is one in one field group.
*The number of scan electrodes 22 applied with a forced initializing waveform in a special initializing subfield (a specified-cell initializing subfield in this exemplary embodiment) is one in one scan electrode group.
*A non-initializing waveform is applied to scan electrodes 22 on both sides of scan electrode 22 applied with a forced initializing waveform in a special initializing subfield (a specified-cell initializing subfield in this exemplary embodiment), in at least two special initializing subfields, i.e. the special initializing subfield, and a special initializing subfield immediately succeeding the special initializing subfield.

A specific example is described with reference to the accompanying drawings.

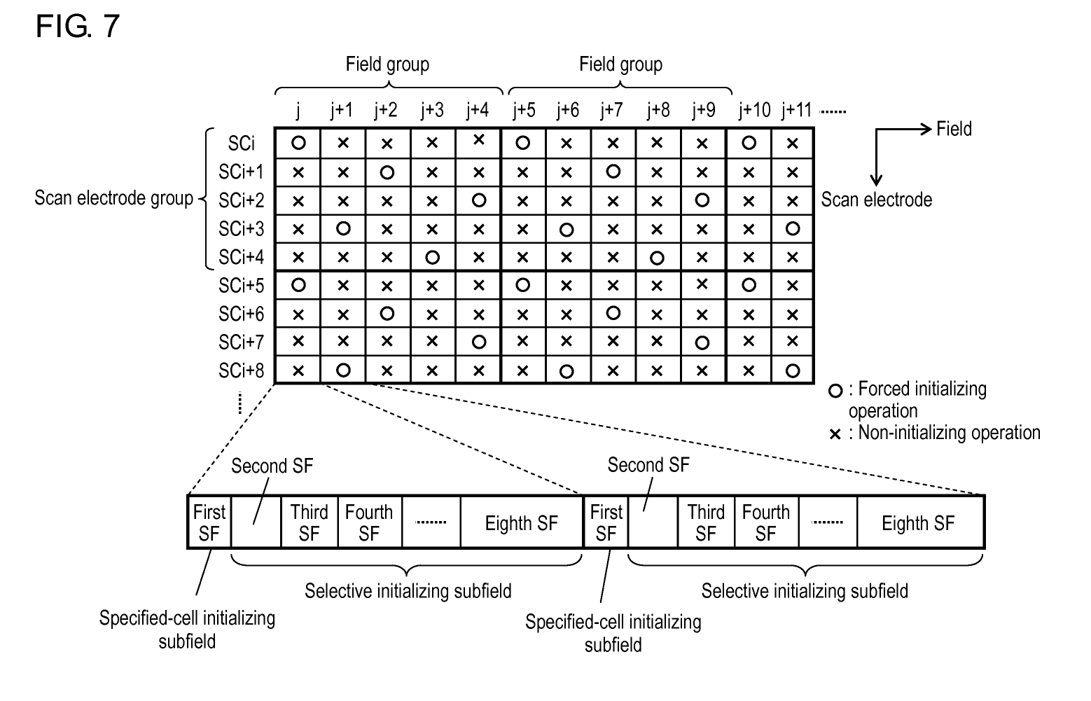

FIG. 7 is a schematic chart showing an example of the pattern of forced initializing waveforms and non-initializing waveforms generated in initializing periods of specified-cell initializing subfields in accordance with the first exemplary embodiment of the present invention. In FIG. 7, the horizontal axis shows fields, and the vertical axis shows scan electrodes 22.

FIG. 7 shows an example where five temporally consecutive fields form one field group, and five positionally consecutive scan electrodes 22 form one scan electrode group. In the example of FIG. 7, the first SF is the above specified-cell initializing subfield, and the remaining subfields (e.g. the second SF through the eighth SF) are the above selective initializing subfields. The mark “∘” in FIG. 7 shows that a forced initializing operation is performed in the initializing period of the first SF. That is, the forced initializing waveform having up-ramp voltage L1 and down-ramp voltage L2 shown in FIG. 6 is applied to scan electrodes 22. The mark “×” in FIG. 7 shows that the above non-initializing operation is performed in the initializing period of the first SF. That is, the non-initializing waveform having up-ramp voltage L1′ and down-ramp voltage L2 shown in FIG. 6 is applied to scan electrodes 22. Hereinafter, a description is provided, using scan electrode SCi through scan electrode SCi+4 forming one scan electrode group and j field through j+4 field forming one field group, as an example.

First, in the first SF of j field, a forced initializing waveform is applied to scan electrode SCi, and a non-initializing waveform is applied to remaining scan electrode SCi+1 through scan electrode SCi+4.

In the first SF of subsequent j+1 field, a forced initializing waveform is applied to scan electrode SCi+3, and a non-initializing waveform is applied to remaining scan electrode SCi through scan electrode SCi+2, and scan electrode SCi+4.

In the first SF of subsequent j+2 field, a forced initializing waveform is applied to scan electrode SCi+1, and a non-initializing waveform is applied remaining scan electrode SCi, and scan electrode SCi+2 through scan electrode SCi+4.

In the first SF of subsequent j+3 field, a forced initializing waveform is applied to scan electrode SCi+4, and a non-initializing waveform is applied to remaining scan electrode SCi through scan electrode SCi+3.

In the first SF of subsequent j+4 field, a forced initializing waveform is applied to scan electrode SCi+2, and a non-initializing waveform is applied to remaining scan electrode SCi, scan electrode SCi+1, scan electrode SCi+3, and scan electrode SCi+4.

In this manner, the operation in one scan electrode group in one field group is completed. In the other scan electrode groups, the operation the same as the above is performed. Also thereafter, the operation the same as the above is repeated in each field group.

In this manner, in this exemplary embodiment, panel 10 is driven by selectively generating the forced initializing waveforms and non-initializing waveforms in a manner such that the number of forced initializing operations performed on each discharge cell is one in one field group (formed of five fields in the example of FIG. 7).

This operation can reduce the frequency of forced initializing operations performed on each discharge cell as compared with that in the structure where the forced initializing operation is performed on all the discharge cells in each field. In the example of FIG. 7, the frequency can be reduced to one-fifth. Therefore, the luminance of black level in the display image can be reduced.

Further, in this exemplary embodiment, panel 10 is driven by selectively generating forced initializing waveforms and non-initializing waveforms in a manner such that the number of scan electrodes 22 applied with the forced initializing waveform in one specified-cell initializing subfield is one in one scan electrode group.

In the example of FIG. 7, in the scan electrode group formed of scan electrode SCi through scan electrode SCi+4, for example, scan electrodes 22 to be applied with a forced initializing waveform are scan electrode SCi in j field, scan electrode SCi+3 in j+1 field, scan electrode SCi+1 in j+2 field, scan electrode SCi+4 in j+3 field, and scan electrode SCi+2 in j+4 field.

With this structure, the discharge cells for undergoing the forced initializing operation can be distributed to each field. That is, the luminance caused in the initializing period of the specified-cell initializing subfield can be reduced as compared with the luminance caused when the forced initializing operation is performed on all the discharge cells of panel 10 at the same time.

Further, this structure can reduce fine flickering called “flickers” as compared with the structure for dividing the respective fields into those where the forced initializing operation is performed on all the discharge cells of panel 10 at the same time and those where the non-initializing operation is performed on all the discharge cells at the same time.

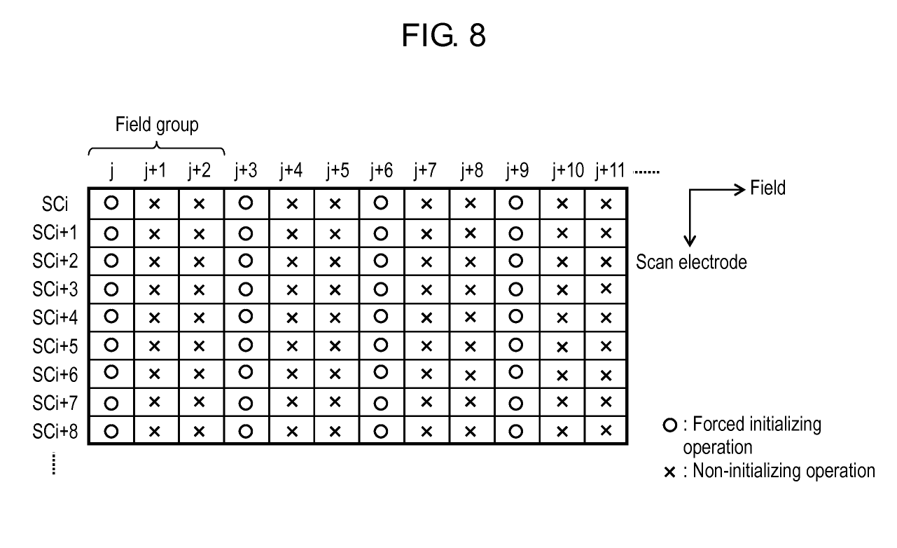

FIG. 8 shows an example of this structure for dividing the respective fields into those where the forced initializing operation is performed on all the discharge cells of panel 10 at the same time and those where the non-initializing operation is performed on all the discharge cells at the same time. Further, the reason why this structure is likely to cause flickers is described.

FIG. 8 is a schematic chart showing an example of the structure for dividing the respective fields into those where a forced initializing operation is performed on all the discharge cells of panel 10 at the same time and those where a non-initializing operation is performed on all the discharge cells at the same time.

FIG. 8 shows an example where three temporally consecutive fields form a field group. However, different from the structure of FIG. 7, in the structure of FIG. 8, an initializing operation is performed on all the discharge cells of panel 10 at a cycle of once every three fields.

With such a structure, in the initializing period of the first SF of j field, for example, all the discharge cells of panel 10 are caused to emit light by the discharge in a forced initializing operation. On the other hand, in the initializing periods of the first SFs of j+1 field and j+2 field, a non-initializing operation is performed on all the discharge cells and thus no light emission is caused by up-ramp voltage. Therefore, a slight difference in luminance occurs on the image display surface of panel 10 between the first SF of j field and the first SFs of j+1 field and j+2 field. For this reason, when an image to be updated at a cycle of 60 fields per second is displayed on panel 10, this slight change in luminance occurs at a cycle of 20 fields per second.

When the display image is sufficiently bright, this luminance change is unlikely to be recognized by the user. However, a luminance change caused at a relatively slow cycle of approximately 20 fields per second as described above can be recognized by the user as fine flickering, i.e. flickers, when a dark image is displayed.

Therefore, even when the frequency of forced initializing operations is reduced so as to decrease the luminance of black level, flickers are likely to be recognized in a structure of FIG. 8 for dividing the respective fields into those where the forced initializing operation is performed on all the discharge cells of panel 10 at the same time and those where the non-initializing operation is performed on all the discharge cells at the same time. Thus, the image display quality can be impaired.

In contrast, when panel 10 is driven in a structure of FIG. 7, for example, of this exemplary embodiment, the discharge cells for undergoing the forced initializing operation can be distributed to each field, and the cycle of the luminance change can be sufficiently shortened. Thus, this structure can reduce flickers as compared with the structure of FIG. 8.

Further, in this exemplary embodiment, panel 10 is driven by selectively generating forced initializing waveforms and non-initializing waveforms in the following manner. That is, a non-initializing waveform is applied to scan electrodes 22 on both sides of scan electrode 22 applied with a forced initializing waveform in a specified-cell initializing subfield, in at least two specified-cell initializing subfields, i.e. the specified-cell initializing subfield in the field, and the specified-cell initializing subfield in the immediately succeeding field.

In the example of FIG. 7, when a forced initializing waveform is applied to scan electrode SCi+3 in the first SF of j+1 field, a non-initializing waveform is applied to scan electrode SCi+2 and scan electrode SCi+4 on both sides, in the first SFs of at least two fields, i.e. j+1 field and j+2 field.

This structure can reduce the continuity of temporal and positional changes of the discharge cells undergoing the forced initializing operation. It is recognized that linear noise is likely to occur on the image display surface of panel 10 when the frequency of forced initializing operations is reduced. In this exemplary embodiment, this structure can reduce this linear noise as compared with the structure where the continuity of temporal and positional changes of the discharge cells undergoing the forced initializing operation is high.

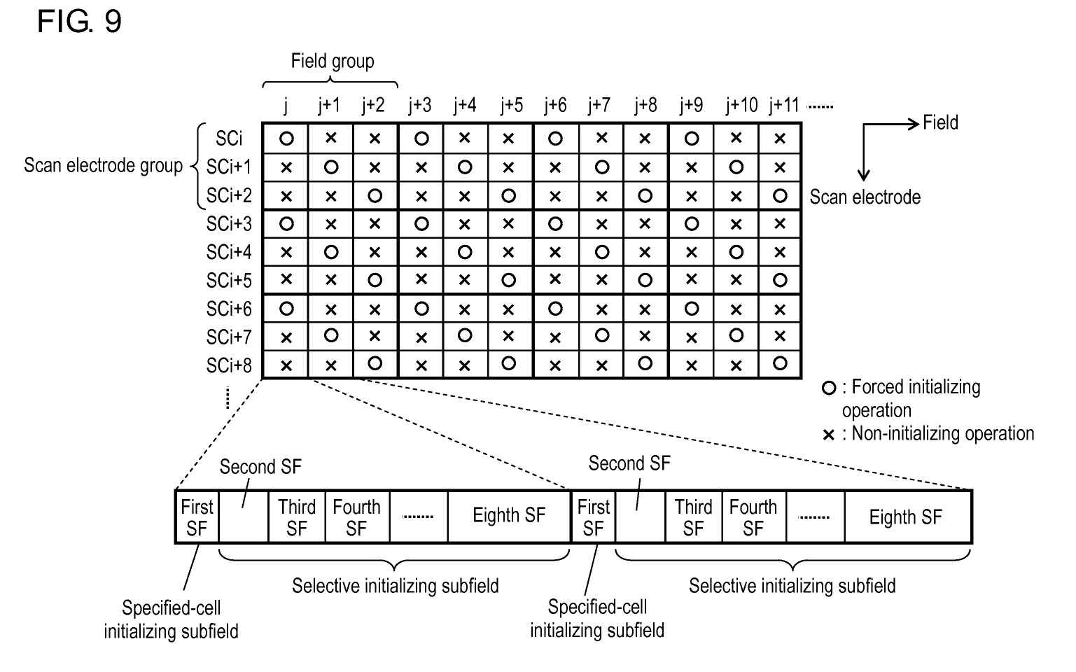

FIG. 9 shows an example of this structure where the continuity of temporal and positional changes of the discharge cells undergoing a forced initializing operation is high, for explanation of the reason why the linear noise is likely to occur.

FIG. 9 is a schematic chart showing an example of the structure where the continuity of temporal and positional changes of the discharge cells undergoing a forced initializing operation is high.

FIG. 9 shows an example where temporally consecutive three fields form one field group and positionally consecutive three scan electrodes 22 form one scan electrode group. However, in the structure of FIG. 9, different from the structure of FIG. 7 in this exemplary embodiment, a forced initializing waveform is applied to scan electrode 22 adjacent to scan electrode 22 having undergone a forced initializing operation, in the specified-cell initializing subfield of the subsequent field.

For example, a forced initializing waveform is applied to scan electrode SCi+1 adjacent to scan electrode SCi applied with a forced initializing waveform in the first SF of j field, in the first SF of subsequent j+1 field. A forced initializing waveform is applied to scan electrode SCi+2 adjacent to scan electrode SCi+1, in the first SF of subsequent j+2 field.

In this structure, in the initializing period of the first SF of j field, the discharge cells formed on scan electrode SCi are caused to emit light by the discharge in the forced initializing operation. In the initializing period of the first SF of subsequent j+1 field, the discharge cells formed on scan electrode SCi+1 are caused to emit light by the discharge in the forced initializing operation. In the initializing period of the first SF of subsequent j+2 field, the discharge cells formed on scan electrode SCi+2 are caused to emit light by the discharge in the forced initializing operation.

In this manner, in the structure of FIG. 9, a forced initializing operation is performed on the discharge cells adjacent to the discharge cells having undergone a forced initializing operation, in the subsequent field. This makes the user likely to recognize that the discharge cells undergoing a forced initializing operation change in a temporally and positionally continuous manner. As a result, the locus of the continuous change is recognized by the user as linear noise with a higher possibility.

However, when panel 10 is driven in the structure of FIG. 7, for example, of this exemplary embodiment, a non-initializing operation is performed and thus no initializing discharge is caused to the discharge cells adjacent to the discharge cells having undergone a forced initializing operation, in the first SFs of at least two fields, i.e. the field and the subsequent field. This operation can reduce the continuity of temporal and positional changes of the discharge cells undergoing the forced initializing operation, and thus reduce the above linear noise.

As described above, in this exemplary embodiment, a plurality of temporally consecutive fields forms one field group, and a plurality of positionally consecutive electrodes 22 forms one scan electrode group. The number of forced initializing waveforms applied to one scan electrode 22 is one in one field group. The number of scan electrodes 22 applied with a forced initializing waveform in a special initializing subfield (a specified-cell initializing subfield in this exemplary embodiment) is one in one scan electrode group. Further, a non-initializing waveform is applied to scan electrodes 22 on both sides of scan electrode 22 applied with a forced initializing waveform in a special initializing subfield (a specified-cell initializing subfield in this exemplary embodiment), in at least two special initializing subfields, i.e. the special initializing subfield and a special initializing subfield immediately succeeding the special initializing subfield. In accordance with these rules, forced initializing waveforms and non-initializing waveforms are generated. This structure can reduce the luminance of black level in the image displayed on panel 10 and enhance the contrast. This structure can also reduce flickers and linear noise likely to occur when the frequency of forced initializing operations is reduced.

In the present invention, the pattern of forced initializing waveforms and non-initializing waveforms generated in a specified-cell initializing subfield is not limited to the structure of FIG. 7. Forced initializing waveforms and non-initializing waveforms may be generated in a pattern different from that of the example of FIG. 7 as long as the pattern of forced initializing waveforms and non-initializing waveforms is in accordance with the rules of this exemplary embodiment.

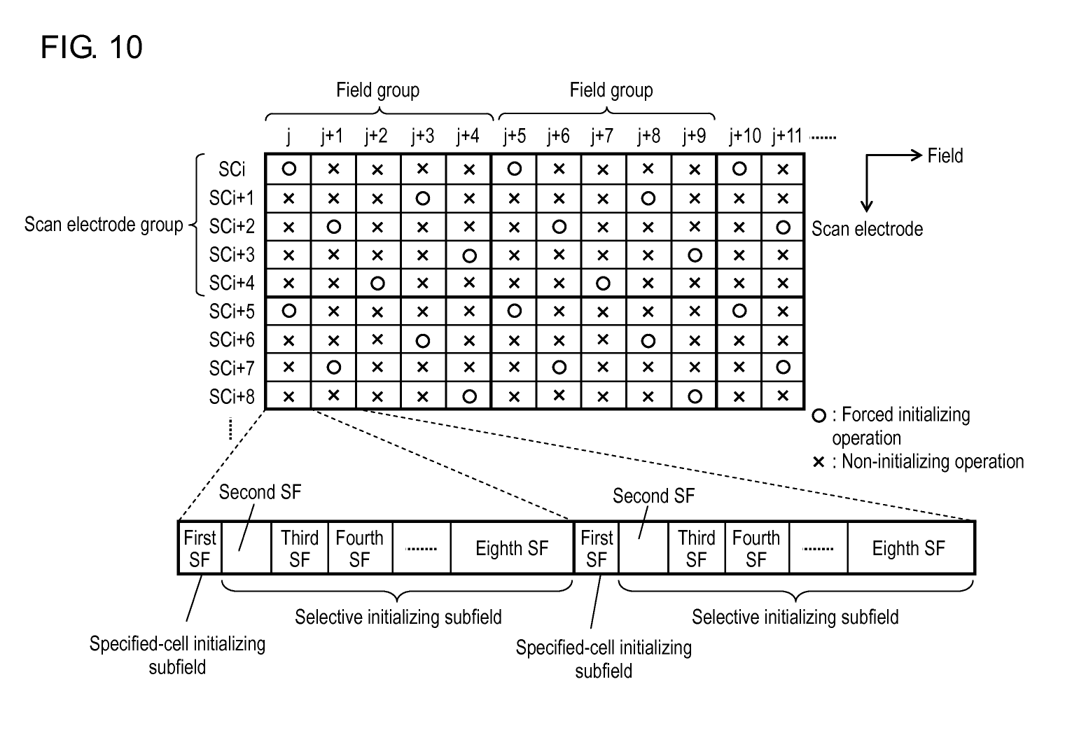

FIG. 10 is a schematic chart showing another example of the pattern of forced initializing waveforms and non-initializing waveforms generated in the initializing periods of specified-cell initializing subfields in accordance with the first exemplary embodiment of the present invention.

Similar to the example of FIG. 7, FIG. 10 shows an example of the structure where five temporally consecutive fields form one field group, and five positionally consecutive scan electrodes 22 form one scan electrode group. However, the pattern of forced initializing waveforms and non-initializing waveforms is different from that in the example of FIG. 7.

In the example of FIG. 10, in the scan electrode group formed of scan electrode SCi through scan electrode SCi+4, for example, scan electrodes 22 to be applied with a forced initializing waveform are scan electrode SCi in j field, scan electrode SCi+2 in j+1 field, scan electrode SCi+4 in j+2 field, scan electrode SCi+1 in j+3 field, and scan electrode SCi+3 in j+4 field.

Also in a generation pattern different from that of the example of FIG. 7, forced initializing waveforms and non-initializing waveforms can be generated in accordance with the above rules.

In the present invention, the number of fields forming a field group and the number of scan electrodes 22 forming a scan electrode group are not limited to those in the structure of FIG. 7. As long as the pattern of forced initializing waveforms and non-initializing waveforms is in accordance with the rules in this exemplary embodiment, the field group may be formed of a number of fields different from that in the example of FIG. 7, and the scan electrode group may be formed of a number of scan electrodes 22 different from that in the example of FIG. 7.

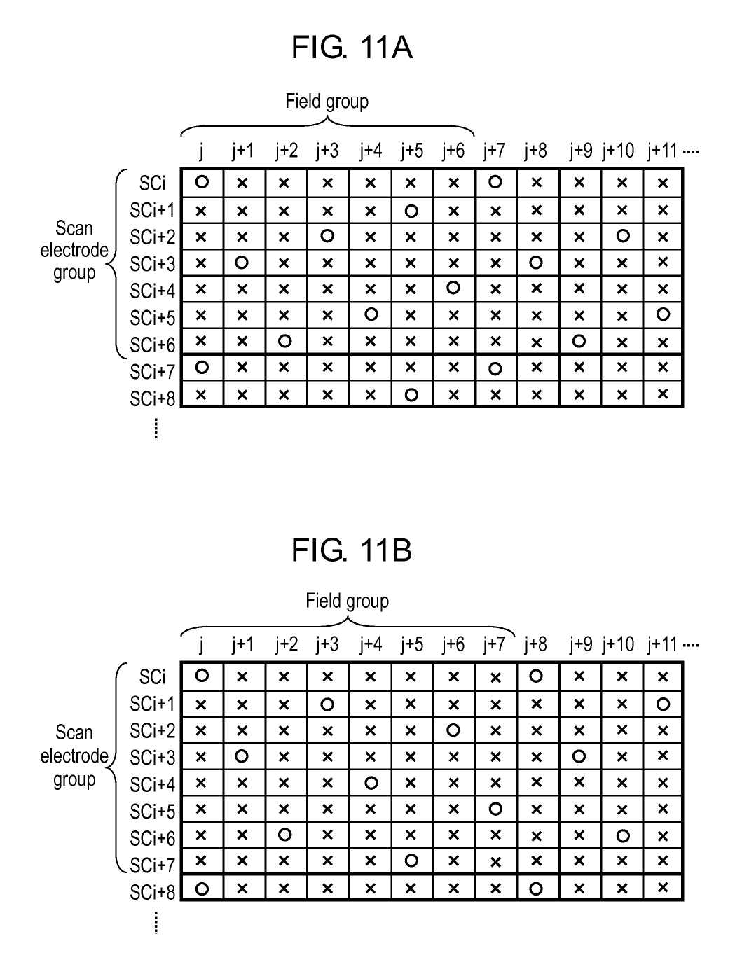

FIG. 11A and FIG. 11B are schematic charts each showing still another example of the pattern of forced initializing waveforms and non-initializing waveforms generated in the initializing periods of specified-cell initializing subfields in accordance with the first exemplary embodiment of the present invention.

Different from the example of FIG. 7, FIG. 11A shows an example of the structure where seven temporally consecutive fields form one field group, and seven positionally consecutive scan electrodes 22 form one scan electrode group. FIG. 11B shows an example of the structure where eight temporally consecutive fields form one field group, and eight positionally consecutive scan electrodes 22 form one scan electrode group.

In the example of FIG. 11A, in the scan electrode group formed of scan electrode SCi through scan electrode SCi+6, for example, scan electrodes 22 to be applied with a forced initializing waveform are scan electrode SCi in j field, scan electrode SCi+3 in j+1 field, scan electrode SCi+6 in j+2 field, scan electrode SCi+2 in j+3 field, scan electrode SCi+5 in j+4 field, scan electrode SCi+1 in j+5 field, and scan electrode SCi+4 in j+6 field.

In the example of FIG. 11B, in the scan electrode group formed of scan electrode SCi through scan electrode SCi+7, for example, scan electrodes 22 to be applied with a forced initializing waveform are scan electrode SCi in j field, scan electrode SCi+3 in j+1 field, scan electrode SCi+6 in j+2 field, scan electrode SCi+1 in j+3 field, scan electrode SCi+4 in j+4 field, scan electrode SCi+7 in j+5 field, scan electrode SCi+2 in j+6 field, and scan electrode SCi+5 in j+7 field.

Also with such a structure, forced initializing waveforms and non-initializing waveforms can be generated in accordance with the above rules.

In this manner, in the present invention, the number of fields forming one field group and the number of scan electrodes 22 forming one scan electrode group are not limited. As long as forced initializing waveforms and non-initializing waveforms are generated in accordance with the rules shown in this exemplary embodiment, the field group and the scan electrode group may be formed in any pattern.

### Second Exemplary Embodiment

In the first exemplary embodiment, a description is provided for a structure where special initializing subfields are all specified-cell initializing subfields. However, in the present invention, special initializing subfields may include an all-cell non-initializing subfield, where a non-initializing waveform is applied to all scan electrodes 22 in the initializing period, for an all-cell non-initializing operation.

In this exemplary embodiment, a description is provided for a structure where special initializing subfields include both specified-cell initializing subfields and all-cell non-initializing subfields. That is, in this exemplary embodiment, one field group is formed of initializing fields and non-initializing fields. Each initializing field has a specified-cell initializing subfield (e.g. the first SF) and a plurality of selective initializing subfields (e.g. the second SF through the eighth SF). Each non-initializing field has an all-cell non-initializing subfield (e.g. the first SF) and a plurality of selective initializing subfields (e.g. the second SF through the eighth SF). In the following description, the initializing field is also referred to as “specified-cell initializing field”.

The structure of this exemplary embodiment is the same as that of the first exemplary embodiment, except that the special initializing subfields include both specified-cell initializing subfields and all-cell non-initializing subfields. Thus, the description of panel 10, the structure of plasma display device 1, each driving waveform, or the like is omitted.

In this exemplary embodiment, one field group is formed of initializing fields and non-initializing fields. Therefore, the rules about the pattern of forced initializing waveforms and non-initializing waveforms as described in the first exemplary embodiment are set as follows.

*The number of forced initializing waveforms applied to one scan electrode 22 is one in one field group.
*The number of scan electrodes 22 applied with a forced initializing waveform in a special initializing subfield is one or zero in one scan electrode group. That is, the number of scan electrodes 22 applied with a forced initializing waveform in each scan electrode group is one in a specified-cell initializing subfield, and zero in an all-cell non-initializing subfield.
*A non-initializing waveform is applied to scan electrodes 22 on both sides of scan electrode 22 applied with a forced initializing waveform in a special initializing subfield (a specified-cell initializing subfield), in at least two special initializing subfields, i.e. the special initializing subfield, and a special initializing subfield (a specified-cell initializing subfield or an all-cell non-initializing subfield in this exemplary embodiment) immediately succeeding the special initializing subfield.

Hereinafter, specific structural examples in this exemplary embodiment are described with reference to the accompanying drawings.

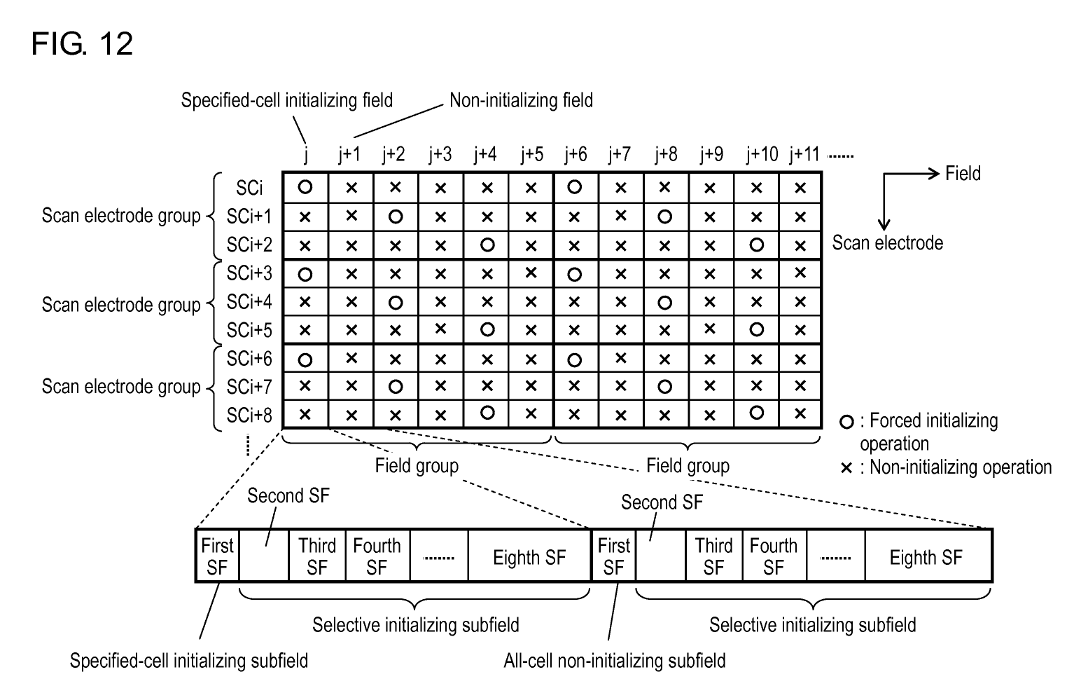

FIG. 12 is a schematic chart showing an example of the pattern of forced initializing waveforms and non-initializing waveforms generated in the initializing periods of special initializing subfields in accordance with the second exemplary embodiment of the present invention. In FIG. 12, the horizontal axis shows fields, and the vertical axis shows scan electrodes 22.

FIG. 12 shows an example of the structure where six temporally consecutive fields form one field group, and three positionally consecutive scan electrodes 22 form one scan electrode group. In the example of FIG. 12, the first SF is a special initializing subfield (a specified-cell initializing subfield or an all-cell non-initializing subfield) and the remaining subfields (e.g. the second SF through the eighth SF) are selective initializing subfields. The mark “∘” in FIG. 12 shows that a forced initializing operation is performed in the initializing period of the first SF. That is, the forced initializing waveform having up-ramp voltage L1 and down-ramp voltage L2 shown in FIG. 6 is applied to scan electrodes 22. The mark “×” in FIG. 12 shows that the above non-initializing operation is performed in the initializing period of the first SF. That is, the non-initializing waveform having up-ramp voltage L1′ and down-ramp voltage L2 shown in FIG. 6 is applied to scan electrodes 22.

Hereinafter, a description is provided, using scan electrode SCi through scan electrode SCi+2 forming one scan electrode group and j field through j+5 field forming one field group, as an example.

First, in the first SF of j field, a forced initializing waveform is applied to scan electrode SCi, and a non-initializing waveform is applied to scan electrode SCi+1 and scan electrode SCi+2.

In the first SF of subsequent j+1 field, a non-initializing waveform is applied to all scan electrodes 22.

In the first SF of subsequent j+2 field, a forced initializing waveform is applied to scan electrode SCi+1, and a non-initializing waveform is applied to scan electrode SCi and scan electrode SCi+2.

In the first SF of subsequent j+3 field, a non-initializing waveform is applied to all scan electrodes 22.

In the first SF of subsequent j+4 field, a forced initializing waveform is applied to scan electrode SCi+2, and a non-initializing waveform is applied to scan electrode SCi and scan electrode SCi+1.

In the first SF of subsequent j+5 field, a non-initializing waveform is applied to all scan electrodes 22.

In this manner, the operation in one scan electrode group in one field group is completed. In the other scan electrode groups, the operation the same as the above is performed. Also thereafter, the operation the same as the above is repeated in each field group. In the structure of FIG. 12, j field, j+2 field, and j+4 field, for example, are specified-cell initializing fields, and j+1 field, j+3 field, and j+5 field, for example, are non-initializing fields.

In this exemplary embodiment, this structure can reduce the frequency of forced initializing operations as compared with the structure where the forced initializing operation is performed on all the discharge cells in each field. In the example of FIG. 12, the frequency can be reduced to one-sixth. Thus, the luminance of black level in the display image can be reduced. Especially in this exemplary embodiment, the non-initializing fields are disposed cyclically. Thus, the luminance of black level can be further reduced as compared with that in the structure of the first exemplary embodiment, when the number of scan electrodes 22 forming the scan electrode group is equal to each other.

Further, similarly to the first exemplary embodiment, in this exemplary embodiment, this structure can distribute the discharge cells for undergoing the forced initializing operation to each field as compared with the structure of FIG. 8 where the forced initializing operation is performed on all the discharge cells of panel 10 at the same time. This structure can make the luminance caused in the initializing period of the specified-cell initializing subfield lower the luminance caused when the forced initializing operation is performed on all the discharge cells of panel 10 at the same time.

In the specified-cell initializing operation in the initializing field, a weak light emission is caused by the initializing discharge. In contrast, in the all-cell non-initializing operation in the non-initializing field, no initializing discharge is caused by up-ramp voltage and thus no light emission is caused by the initializing discharge. For this reason, different from the first exemplary embodiment, a slight difference in luminance is caused on the image display surface of panel 10 between these fields. Therefore, in the structure of FIG. 12 where the initializing field for the specified-cell initializing operation and the non-initializing field for the all-cell non-initializing operation are alternately disposed, when an image to be updated at a cycle of 60 fields per second is displayed on panel 10, this slight change in luminance occurs at a cycle of 30 fields per second.

However, in this exemplary embodiment, as described above, the luminance caused in the initializing period of the specified-cell initializing subfield is reduced. In the structure of FIG. 12, the luminance is reduced to one-third of that in the structure where the forced initializing operation is performed on all the discharge cells of panel 10 at the same time. Thus, this change in luminance is extremely small on the image display surface of panel 10. Therefore, it is considered that this luminance change is recognized by the user with an extremely low possibility. Actually, in the experiments conducted by the inventor, i.e. the experiments for checking flickers in a display image changed in various manners, substantially no flickers are observed.

In this exemplary embodiment, similarly to the first exemplary embodiment, the above structure can reduce the continuity of temporal and positional changes of the discharge cells undergoing the forced initializing operation. This structure can reduce linear noise likely to occur on the image display surface of panel 10 when the frequency of forced initializing operations is reduced as compared with the structure of FIG. 9, for example, where the continuity of the temporal and positional changes of the discharge cells undergoing a forced initializing operation is high.

Especially in this exemplary embodiment, the non-initializing fields are disposed cyclically. This structure can further reduce the continuity of the temporal and positional changes of the discharge cells undergoing a forced initializing operation and suppress the occurrence of the above linear noise as compared with the structure of the first exemplary embodiment, i.e. the structure where a field group is formed of initializing fields only.

In the present invention, the pattern of forced initializing waveforms and non-initializing waveforms generated in specified-cell initializing subfields is not limited to the structure of FIG. 12.

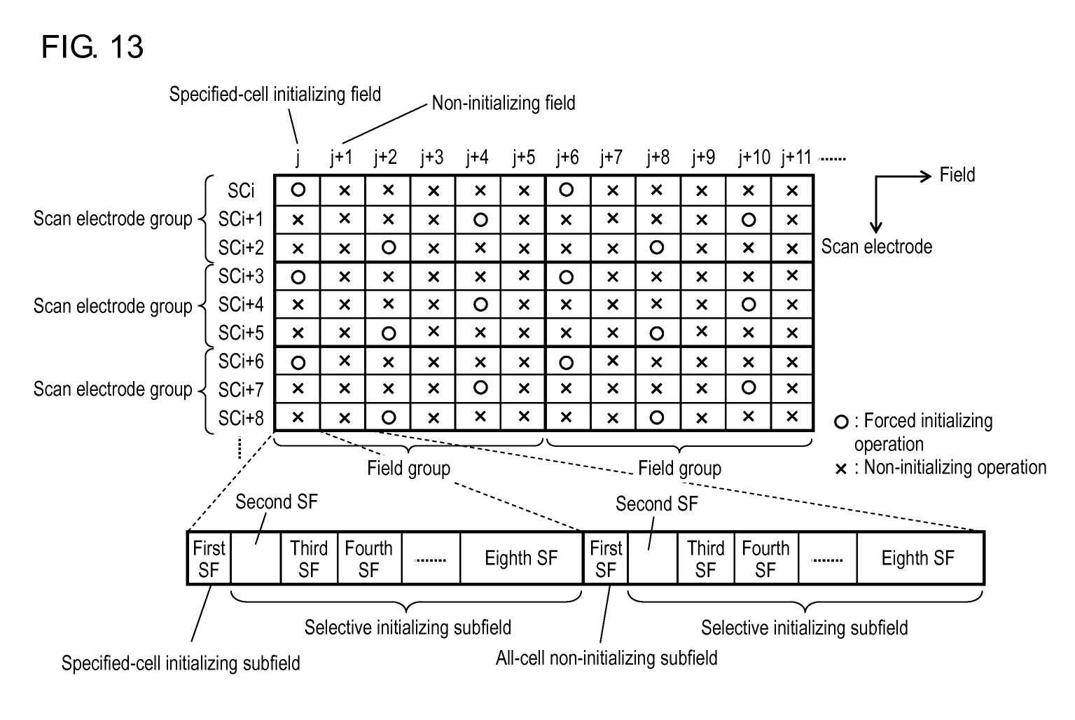

FIG. 13 is a schematic chart showing another example of the pattern of forced initializing waveforms and non-initializing waveforms generated in the initializing periods of special initializing subfields in accordance with the second exemplary embodiment of the present invention.

Similar to the example of FIG. 12, FIG. 13 shows an example of the structure where six temporally consecutive fields form one field group, and three positionally consecutive scan electrodes 22 form one scan electrode group. However, the pattern of forced initializing waveforms and non-initializing waveforms is different from that of the example of FIG. 12.

In the example of FIG. 13, j field, j+2 field, and j+4 field, for example, are specified-cell initializing fields, and j+1 field, j+3 field, and j+5 field, for example, are non-initializing fields.

In the scan electrode group formed of scan electrode SCi through scan electrode SCi+2, for example, scan electrodes 22 to be applied with a forced initializing waveform are scan electrode SCi in j field, scan electrode SCi+2 in j+2 field, and scan electrode SCi+1 in j+4 field.

In this manner, also in a generation pattern different from that of the example of FIG. 12, forced initializing waveforms and non-initializing waveforms can be generated in accordance with the above rules.

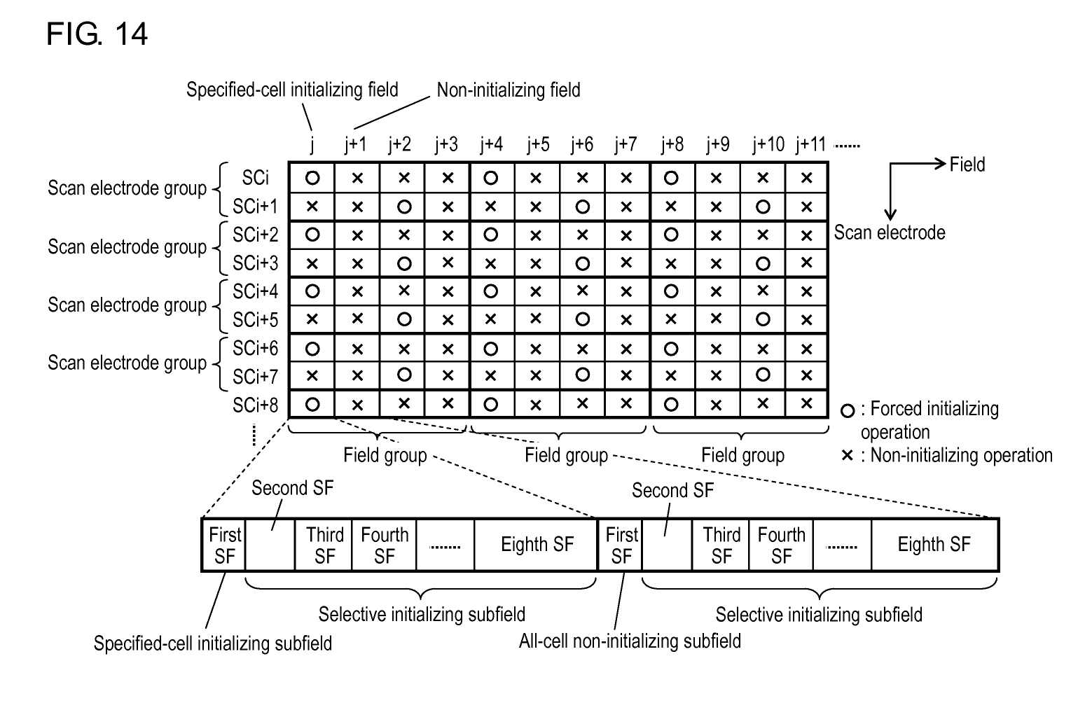

FIG. 14 is a schematic chart showing still another example of the pattern of forced initializing waveforms and non-initializing waveforms generated in the initializing periods of special initializing subfields in accordance with the second exemplary embodiment of the present invention.

Different from the example of FIG. 12, FIG. 14 shows an example of the structure where four temporally consecutive fields form one field group, and two positionally consecutive scan electrodes 22 form one scan electrode group.

In the example of FIG. 14, j field, j+2 field, and j+4 field, for example, are specified-cell initializing fields, and j+1 field, j+3 field, and j+5 field, for example, are non-initializing fields.

In the scan electrode group formed of scan electrode SCi and scan electrode SCi+1, for example, scan electrodes 22 to be applied with a forced initializing waveform are scan electrode SCi in j field and scan electrode SCi+1 in j+2 field.

Also with such a structure, forced initializing waveforms and non-initializing waveforms can be generated in accordance with the above rules.

With reference to FIG. 12, FIG. 13, and FIG. 14, a description is provided for a structure where specified-cell initializing fields and non-initializing fields are disposed alternately with each other. However, the present invention is not limited to this structure. In one field group, the number of specified-cell initializing fields may be different from the number of non-initializing fields.

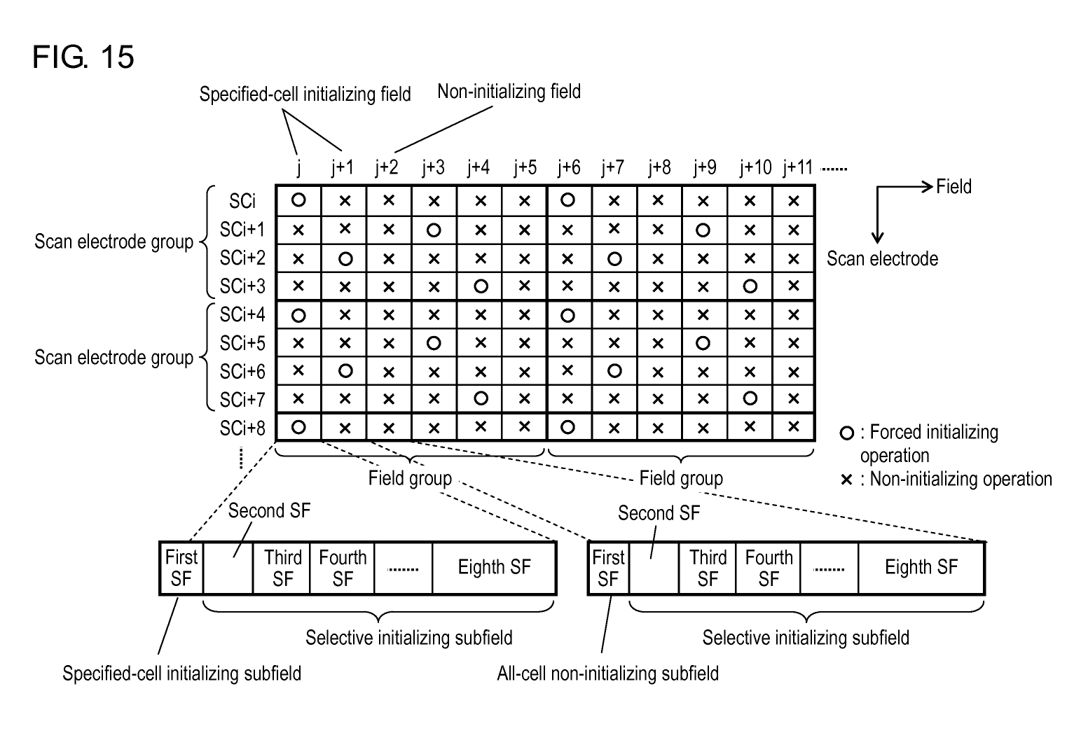

FIG. 15 is a schematic chart showing yet another example of the pattern of forced initializing waveforms and non-initializing waveforms generated in the initializing periods of special initializing subfields in accordance with the second exemplary embodiment of the present invention.

FIG. 15 shows an example of the structure where six temporally consecutive fields form one field group, four positionally consecutive scan electrodes 22 form one scan electrode group, and the number of specified-cell initializing fields is greater than the number of non-initializing fields.

In the example of FIG. 15, j field, j+1 field, j+3 field, and j+4 field, for example, are specified-cell initializing fields, and j+2 field, j+5 field, and j+8 field, for example, are non-initializing fields.

In the scan electrode group formed of scan electrode SCi through scan electrode SCi+3, for example, scan electrodes 22 to be applied with a forced initializing waveform are scan electrode SCi in j field, scan electrode SCi+2 in j+1 field, scan electrode SCi+1 in j+3 field, and scan electrode SCi+3 in j+4 field.

Also with such a structure, forced initializing waveforms and non-initializing waveforms can be generated in accordance with the above rules.

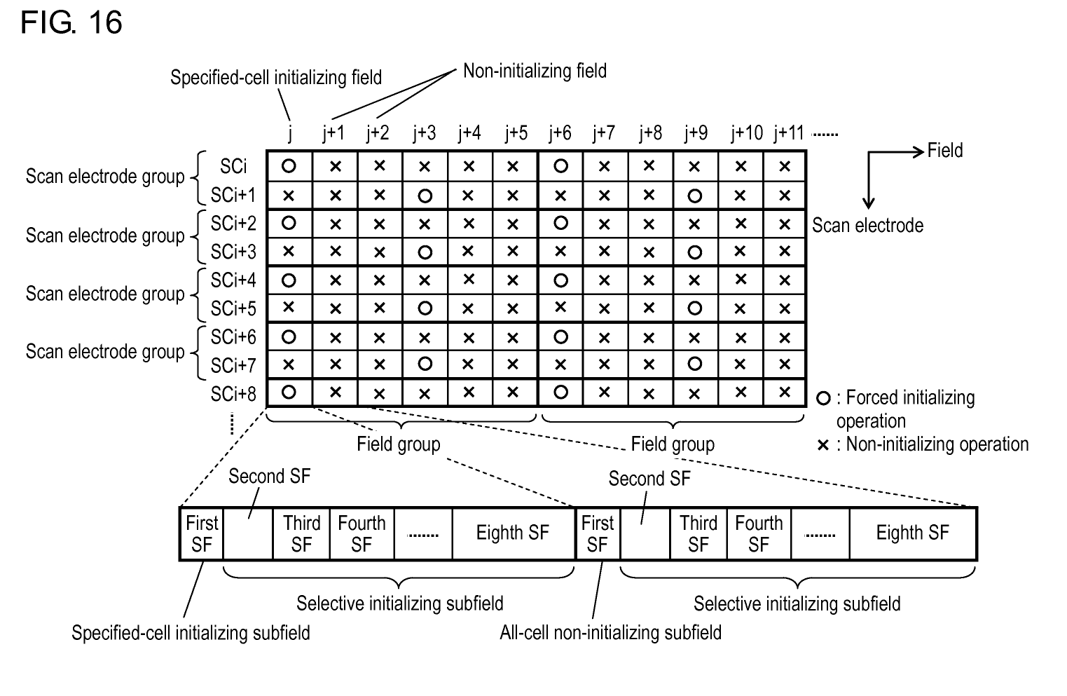

FIG. 16 is a schematic chart showing still another example of the pattern of forced initializing waveforms and non-initializing waveforms generated in the initializing periods of special initializing subfields in accordance with the second exemplary embodiment of the present invention.

FIG. 16 shows an example of the structure where six temporally consecutive fields form one field group, two positionally consecutive scan electrodes 22 form one scan electrode group, and the number of specified-cell initializing fields is smaller than the number of non-initializing fields.

In the example of FIG. 16, j field, j+3 field, and j+6 field, for example, are specified-cell initializing fields, and j+1 field, j+2 field, j+4 field, and j+5 field, for example, are non-initializing fields.

In the scan electrode group formed of scan electrode SCi and scan electrode SCi+1, for example, scan electrodes 22 to be applied with a forced initializing waveform are scan electrode SCi in j field, and scan electrode SCi+1 in j+3 field.

Also with such a structure, forced initializing waveforms and non-initializing waveforms can be generated in accordance with the above rules.

As described above, in this exemplary embodiment, one field group is formed of initializing fields each having a specified-cell initializing subfield and a plurality of selective initializing subfields, and non-initializing fields each having an all-cell non-initializing subfield and a plurality of selective initializing subfields. Further, the number of forced initializing waveforms applied to one scan electrode 22 is one in one field group. The number of scan electrodes 22 applied with a forced initializing waveform in a special initializing subfield is one or zero in one scan electrode group. That is, the number of scan electrodes 22 applied with a forced initializing waveform in each scan electrode group is one in a specified-cell initializing subfield, and zero in an all-cell non-initializing subfield. Further, a non-initializing waveform is applied to scan electrodes 22 on both sides of scan electrode 22 applied with a forced initializing waveform in a special initializing subfield (a specified-cell initializing subfield), in at least two special initializing subfields, i.e. the special initializing subfield, and a special initializing subfield (a specified-cell initializing subfield or an all-cell non-initializing subfield) immediately succeeding the special initializing subfield. In accordance with these rules, forced initializing waveforms and non-initializing waveforms are generated. While reducing flickers or linear noise likely to occur when the frequency of forced initializing operations is reduced, this structure further reduces the luminance of black level in the image displayed on panel 10 so as to enhance the contrast.

The wall charge formed by initializing discharge in discharge cells gradually decreases with a lapse of time. As the period during which no initializing discharge occurs is increased, the amount of the decrease increases.

Therefore, when the period during which no initializing discharge occurs is excessively long, an address operation cannot be performed normally. For this reason, when an image to be updated at a cycle of 60 fields per second is displayed in the first and second exemplary embodiments, it is preferable that the number of fields forming one field group is set to 20 or smaller so that an initializing discharge is caused in all the discharge cells at least once every 20 fields.

The timing chart of FIG. 6 only shows an example in the exemplary embodiments of the present invention, and the present invention is not limited to such a timing chart.

The exemplary embodiments of the present invention can also be applied to a method for driving a panel by so-called two-phase driving. In the two-phase driving, scan electrode SC1 through scan electrode SCn are divided into a first scan electrode group and a second scan electrode group. Further, each address period is formed of two address periods, i.e. a first address period where a scan pulse is applied to each scan electrode belonging to the first scan electrode group, and a second address period where the scan pulse is applied to each scan electrode belonging to the second scan electrode group.

The exemplary embodiments of the present invention are also effective in a panel having an electrode structure where a scan electrode is adjacent a scan electrode and a sustain electrode is adjacent to a sustain electrode. In this electrode structure, the electrodes are arranged on the front plate in the following order: a scan electrode, a scan electrode, a sustain electrode, a sustain electrode, a scan electrode, a scan electrode, or the like.

The specific numerical values in the exemplary embodiments, e.g. the gradients of up-ramp voltage L1, down-ramp voltage L2, and erasing ramp voltage L3, are based on the characteristics of a 50-inch panel having 1080 display electrode pairs, and only show examples in the exemplary embodiments. The present invention is not limited to these numerical values. Preferably, numerical values are set optimally for the characteristics of the panel, the specifications of the plasma display device, or the like. For each of these numerical values, variations are allowed within the range where the above advantages can be obtained.

### INDUSTRIAL APPLICABILITY

The present invention can reduce the luminance of black level in the image displayed on a panel so as to enhance the contrast and image display quality. Thus, the present invention is useful as a driving method for a panel, and a plasma display device.

### REFERENCE SIGNS LIST

1 Plasma display device
10 Panel (Plasma display panel)
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driving circuit
43 Scan electrode driving circuit
44 Sustain electrode driving circuit
45 Timing generating circuit
50 Sustain pulse generating circuit
51 Initializing waveform generating circuit
52 Scan pulse generating circuit
53, 54, 55 Miller integrating circuit
Q1, Q2, Q3, Q4, Q5, Q6, QH1 through QHn, QL1 through QLn, Switching element
C1, C2, C3, C31 Capacitor
Di31 Diode
R1, R2, R3 Resistor
L1 Up-ramp voltage
L2, L4 Down-ramp voltage
L3 Erasing ramp voltage

1. A driving method for a plasma display panel,
the plasma display panel having a plurality of discharge cells, the discharge cells having display electrode pairs, each of the display electrode pairs being formed of a scan electrode and a sustain electrode,
the plasma display panel displaying gradations such that a plurality of subfields is set in one field and each of the subfields has an initializing period, an address period, and a sustain period,
the driving method comprising:
applying any one of a forced initializing waveform, a selective initializing waveform and a non-initializing waveform to the scan electrodes, the forced initializing waveform causing an initializing discharge in the discharge cells irrespective of an operation in the immediately preceding subfield, the selective initializing waveform causing an initializing discharge only in the discharge cells having undergone a sustain discharge in the sustain period of the immediately preceding subfield, the non-initializing waveform causing no initializing discharge in the discharge cells;
forming one field from a special initializing subfield and a plurality of selective initializing subfields, the special initializing subfield being where the forced initializing waveform or the non-initializing waveform is selectively applied to the scan electrodes in the initializing period, and the plurality of selective initializing subfields being where the selective initializing waveform is applied to all the scan electrodes in the initializing period;
forming one field group from the plurality of temporally consecutive fields, and setting the number of forced initializing waveforms to be applied to each of the scan electrodes to one in the one field group; and
applying the non-initializing waveform to the scan electrodes on both sides of the scan electrode applied with the forced initializing waveform in the special initializing subfield, in at least two special initializing subfields including the special initializing subfield and a special initializing subfield immediately succeeding the special initializing subfield.

2. The driving method for the plasma display panel of claim 1, wherein
a scan electrode group is formed of the plurality of scan electrodes that are consecutively positioned, and
the number of scan electrodes applied with the forced initializing waveform in one of the special initializing subfields is one or zero, in each of the scan electrode groups.

3. The driving method for the plasma display panel of claim 1, wherein
the special initializing subfield is set as either a specified-cell initializing subfield or an all-cell non-initializing subfield, the specified-cell initializing subfield being where the forced initializing waveform is applied to predetermined scan electrodes and the non-initializing waveform is applied to other scan electrodes in the initializing period, and the all-cell non-initializing subfield being where the non-initializing waveform is applied to all the scan electrodes in the initializing period, and
the field group is formed of an initializing field and a non-initializing field, the initializing field having the specified-cell initializing subfield and the plurality of selective initializing subfields, and the non-initializing field having the all-cell non-initializing subfield and the plurality of selective initializing subfields.

4. The driving method for the plasma display panel of claim 3, wherein the field group is formed such that the initializing field is disposed alternately with the non-initializing field.

5. The driving method for the plasma display panel of claim 1, wherein the number of fields forming the one field group is equal to or smaller than 20.

6. A plasma display device comprising:
a plasma display panel driven by a subfield method for gradation display,
in the subfield method, a plurality of subfields being set in one field, each of the subfields having an initializing period, an address period, and a sustain period; the one field being formed of a special initializing subfield and a plurality of selective initializing subfields; one field group being formed of the plurality of temporally consecutive fields,
the plasma display panel having a plurality of discharge cells, the discharge cells having display electrode pairs, each of the display electrode pairs being formed of a scan electrode and a sustain electrode; and
a scan electrode driving circuit for
applying any one of a forced initializing waveform, a selective initializing waveform, and a non-initializing waveform to the scan electrodes in the initializing period, the forced initializing waveform causing an initializing discharge in the discharge cells irrespective of an operation in the immediately preceding subfield, the selective initializing waveform causing an initializing discharge only in the discharge cells having undergone a sustain discharge in the sustain period of the immediately preceding subfield, and the non-initializing waveform causing no initializing discharge in the discharge cells, and
applying the forced initializing waveform or the non-initializing waveform to the scan electrodes in the initializing period of the special initializing subfield, selectively; applying the selective initializing waveform to all the scan electrodes and applying the forced initializing waveform to one of the scan electrodes only once in the one field group in the initializing period of the selective initializing subfield,
wherein the scan electrode driving circuit generates driving waveforms including at least one generation pattern of driving waveforms in the one field group, in a manner such that, in the generation pattern of driving waveforms, the non-initializing waveform is applied to the scan electrodes on both sides of the scan electrode applied with the forced initializing waveform in the special initializing subfield, in at least two special initializing subfields including the special initializing subfield and a special initializing subfield immediately succeeding the special initializing subfield.

7. The plasma display device of claim 6, wherein
the scan electrode driving circuit has a ramp voltage generating circuit for generating a rising ramp voltage, and
the scan electrode driving circuit outputs a voltage where a predetermined voltage is superimposed on the ramp voltage output from the ramp voltage generating circuit, as the forced initializing waveform, and outputs the ramp voltage where the predetermined voltage is not superimposed, as the non-initializing waveform.

8. The driving method for the plasma display panel of claim 2, wherein the number of fields forming the one field group is equal to or smaller than 20.

9. The driving method for the plasma display panel of claim 3, wherein the number of fields forming the one field group is equal to or smaller than 20.

10. The driving method for the plasma display panel of claim 4, wherein the number of fields forming the one field group is equal to or smaller than 20.
